(19) United States
(12) Patent Application Publication
(10) Pub. No.: US 2026/0210730 A1
(43) Pub. Date: Jul. 23, 2026

(54) MUSIC COMPILATION SYSTEMS AND RELATED METHODS

(71) Applicant: Dial House, LLC, Healdsburg, CA (US)

(72) Inventor: Alex Wipperfürth, San Francisco, CA (US)

(21) Appl. No.: 19/447,859

(22) Filed: Jan. 13, 2026

Related U.S. Application Data
(63) Continuation of application No. 18/982,864, filed on Dec. 16, 2024.
Application No. 18/982,864 is a continuation-in-part of application No. 18/168,284, filed on Feb. 13, 2023.
Application No. 18/168,284 is a continuation-in-part of application No. 16/516,061, filed on Jul. 18, 2019, now Pat. No. 11,580,941.
Application No. 16/516,061 is a continuation-in-part of application No. 16/390,931, filed on Apr. 22, 2019, now Pat. No. 11,928,310.
(60) Provisional application No. 62/661,982, filed on Apr. 24, 2018.

(51) Int. Cl. G01C 21/36; G01C 21/34

(52) U.S. Cl. CPC G01C 21/367; G01C 21/3469; G01C 21/3614; G01C 21/3682; G01C 21/3694; G01C 21/3697

(57) ABSTRACT

A music compilation system includes a computer processor and a media storing instructions executable by the processor. The instructions, when executed, facilitate the music compilation system performing operations including: storing data in one or more databases, the data associating a user with access credentials for one or more music libraries; and in response to receiving a user selection, initiating play of a music set, the music set including one or more portions of each of plural audio tracks. In some implementations the system determines the portions of the plural audio tracks at least in part based on contextual information. In some implementations the system compiles the music set by mixing portions of audio tracks by transitioning from a first portion of an audio track to a second portion of an audio track where the two portions of audio tracks are similar in one or more of harmony, tempo and beat.

### CROSS REFERENCE TO RELATED APPLICATIONS

This document is a continuation of U.S. Nonprovisional patent application Ser. No. 18/168,284, entitled “Vehicle Systems and Related Methods,” naming as first inventor Alex Wipperfurth, which was filed on Feb. 13, 2023, which in turn is a continuation-in-part of U.S. Nonprovisional patent application Ser. No. 16/516,061, entitled “Music Compilation Systems And Related Methods,” naming as first inventor Alex Wipperfurth, which was filed on Jul. 18, 2019, which in turn is a continuation-in-part of U.S. Nonprovisional patent application Ser. No. 16/390,931, entitled “Vehicle Systems and Interfaces and Related Methods,” naming as first inventor Alex Wipperfurth, which was filed on Apr. 22, 2019, which in turn claims the benefit of the filing date of U.S. Provisional Patent Application No. 62/661,982, entitled “Supplemental In-Vehicle (Passenger and Lifestyle Focused) System and Interface,” naming as first inventor Alex Wipperfurth, which was filed on Apr. 24, 2018, the disclosures of each of which are incorporated entirely herein by reference, and each of which are referred to hereinafter as “Parent applications.”

### BACKGROUND

### 1. Technical Field

Aspects of this document relate generally to systems and methods for music compilation and playback.

### 2. Background Art

Various musical compilation systems exist in the art. Some of these utilize mobile device applications and/or website interfaces for allowing a user to stream music which is stored in a remote database or server. Some existing systems allow a user to download music in addition to streaming. Traditional methods of determining which songs to include in a compilation include selecting based on musical genre and/or similarities between the songs themselves.

### SUMMARY

In some aspects, the techniques described herein relate to a music compilation system, including: a computer processor; and a media storing instructions executable by the computer processor, wherein the instructions, when executed, facilitate the music compilation system performing operations including: storing data in one or more databases, the data associating a user with access credentials for one or more music libraries; and in response to receiving a user selection, initiating play of a music set, wherein the music set includes one or more portions of each of plural audio tracks; wherein the system determines the portions of the plural audio tracks at least in part based on contextual information; and wherein the contextual information includes: a listening history for the user; and one or more of: a time of day in which the music set is being played; a day of week on which the music set is being played; a regularity of an occasion in which the music set is being played; a state of mind of the user; a type of device on which the music set is being played; and a location at which the music set is being played.

In some aspects, the techniques described herein relate to a system, wherein the contextual information includes both the time of day in which the music set is being played and the day of week on which the music set is being played.

In some aspects, the techniques described herein relate to a system, wherein the contextual information further includes one or more of: a purpose of an occasion for which the music set is being played; and a social dynamic at the location.

In some aspects, the techniques described herein relate to a system, wherein the contextual information further includes one or more of: a type of the location in which the music set is being played; and a condition of the location in which the music set is being played.

In some aspects, the techniques described herein relate to a system, wherein the type of location includes one or more of: a road type; a location at, approaching, or leaving a home; a location at, approaching, or leaving work; a location at, approaching, or leaving a gym or exercise location; a location at, approaching, or leaving a restaurant; an in-vehicle location; a public location; and an art studio.

In some aspects, the techniques described herein relate to a system, wherein the condition includes one or more of: a temperature; an air pressure; a light condition external to a vehicle; a light condition internal to the vehicle; a weather condition; a road condition; a traffic condition; a position of one or more seats of the vehicle; a volume level; a window configuration of the vehicle; an air conditioning setting; and a heating setting.

In some aspects, the techniques described herein relate to a system, wherein the contextual information does not include a user selection.

In some aspects, the techniques described herein relate to a system, wherein the system compiles the music set by mixing portions of audio tracks by transitioning from a first portion of an audio track to a second portion of an audio track where the two portions of audio tracks are similar in one or more of harmony, tempo and beat.

In some aspects, the techniques described herein relate to a system, wherein the transition from the first portion of an audio track to the second portion of an audio track is where the two portions of audio tracks are most similar in one or more of harmony, tempo, and beat.

In some aspects, the techniques described herein relate to a system, wherein the system determines where the two portions of audio tracks are similar by analyzing sound profiles of the two portions of audio tracks.

In some aspects, the techniques described herein relate to a system, wherein the system automatically modifies one of the two portions of audio tracks to increase its similarity to the other portion.

In some aspects, the techniques described herein relate to a system, wherein the system adjusts one of a volume and a frequency of one of the two portions of audio tracks to increase its similarity to the other portion.

In some aspects, the techniques described herein relate to a system, wherein transitioning from the first portion of an audio track to the second portion of an audio track includes looping at least a part of one of the two portions.

In some aspects, the techniques described herein relate to a system, wherein transitioning from the first portion of an audio track to the second portion of an audio track includes aligning rhythmic notes of the two portions of audio tracks.

In some aspects, the techniques described herein relate to a system, wherein: the audio tracks are categorized according to one or more of, a tempo, an approachability, an engagement, and a sentiment; wherein: the tempo is defined as beats per minute; the approachability is defined by one or more of chord progression, time signature, genre, motion of melody, complexity of texture, and instrument composition; the engagement is defined by one or more of dynamics, pan effect, harmony complexity, vocabulary range, and word count; and the sentiment is defined by one or more of chord type, chord progression, and lyric content; and wherein the system determines the portions of the plural audio tracks at least in part based on the categorization.

In some aspects, the techniques described herein relate to a system, wherein the contextual information is updated and the music set is modified based on a change in the contextual information.

In some aspects, the techniques described herein relate to a music compilation system, including: a computer processor; and a media storing instructions executable by the computer processor, wherein the instructions, when executed, facilitate the music compilation system performing operations including: storing data in one or more databases, the data associating a user with access credentials for one or more music libraries; and in response to receiving a user selection, initiating play of a music set, wherein the music set includes one or more portions of each of plural audio tracks; wherein the system compiles the music set by mixing portions of audio tracks by transitioning from a first portion of an audio track to a second portion of an audio track where the two portions of audio tracks are similar in one or more of harmony, tempo and beat; and wherein the system determines where the two portions of audio tracks are similar by analyzing sound profiles of the two portions of audio tracks.

In some aspects, the techniques described herein relate to a system, wherein the system automatically modifies one of the two portions of audio tracks to increase its similarity to the other portion, and wherein the modification includes one or more of: adjusting a volume of one of the two portions; and adjusting a frequency of one of the two portions.

In some aspects, the techniques described herein relate to a system, wherein transitioning from the first portion of an audio track to the second portion of an audio track includes looping at least a part of one of the two portions.

In some aspects, the techniques described herein relate to a system, wherein transitioning from the first portion of an audio track to the second portion of an audio track includes aligning rhythmic notes of the two portions of audio tracks.

General details of the above-described embodiments, and other embodiments, are given below in the DESCRIPTION, the DRAWINGS, and the CLAIMS.

### BRIEF DESCRIPTION OF THE DRAWINGS

Embodiments will be discussed hereafter using reference to the included drawings, briefly described below, wherein like designations refer to like elements:

FIG. 1 is a diagram view of an implementation of a music compilation system;

FIG. 1A is a front view of a vehicle dashboard having a display on which user interfaces of the system of FIG. 1 may be displayed;

FIG. 1B is a block diagram representatively illustrating example processes implemented by the system of FIG. 1;

FIG. 1C is a diagram of an example user interface of the system of FIG. 1;

FIG. 2 is a flow diagram representatively illustrating elements of an example music compilation method implemented using the system of FIG. 1;

FIG. 3 is a flow diagram representatively illustrating other elements of the example music compilation method of FIG. 2;

FIG. 4 is a table representatively illustrating other elements of the example music compilation method of FIG. 2;

FIG. 5 is a set of tables representatively illustrating other elements of the example music compilation method of FIG. 2;

FIG. 6 is a diagram representatively illustrating other elements of the example music compilation method of FIG. 2;

FIG. 7 is a diagram representatively illustrating other elements of the example music compilation method of FIG. 2;

FIG. 8 is a table representatively illustrating other elements of the example music compilation method of FIG. 2;

FIG. 8A is a table representatively illustrating elements of an example music compilation method implemented using the system of FIG. 1;

FIG. 9 is a diagram representatively illustrating other elements of the example music compilation method of FIG. 2;

FIG. 10 is a diagram representatively illustrating other elements of the example music compilation method of FIG. 2;

FIG. 10A is a diagram representatively illustrating elements of the example music compilation method of FIG. 18;

FIG. 10B is a diagram representatively illustrating music compilation elements implemented using the system of FIG. 1;

FIG. 10C is a diagram representatively illustrating music compilation elements implemented using the system of FIG. 1;

FIG. 10D is a diagram representatively illustrating music compilation elements implemented using the system of FIG. 1;

FIG. 10E is a diagram representatively illustrating music compilation elements implemented using the system of FIG. 1;

FIG. 11 is a diagram representatively illustrating other elements of the example music compilation method of FIG. 2;

FIG. 12 is a diagram representatively illustrating other elements of the example music compilation method of FIG. 2;

FIG. 13 representatively illustrates a user interface implemented using the system of FIG. 1;

FIG. 14 representatively illustrates another user interface implemented using the system of FIG. 1;

FIG. 15 representatively illustrates another user interface implemented using the system of FIG. 1;

FIG. 16 representatively illustrates another user interface implemented using the system of FIG. 1;

FIG. 17 representatively illustrates a vehicle system which may be accessed and/or utilized by the system of FIG. 1 to implement music compilation;

FIG. 17A is a block diagram of a subset of elements of the system of FIG. 1 which may exist in or on a vehicle;

FIG. 17B is a block diagram representatively illustrating relationships between elements, and methods associated with elements, of the system of FIG. 1;

FIG. 18 is a flowchart representatively illustrating an example music compilation method implemented using the system of FIG. 1;

FIG. 19 is a block diagram representatively illustrating example vehicle sensors referenced in FIGS. 17 and 17A;

FIG. 20 representatively illustrates an environment of use of the system of FIG. 1 in which the system determines a distracted state of a driver and initiates a safety alert;

FIG. 21 representatively illustrates data that may be gathered by various sensors of the system of FIG. 1 and determinations the system of FIG. 1 may make using such data; and

FIG. 22 representatively illustrates various interventions implemented using the system of FIG. 1 based on various states of driving.

### DESCRIPTION

Implementations/embodiments disclosed herein (including those not expressly discussed in detail) are not limited to the particular components or procedures described herein. Additional or alternative components, assembly procedures, and/or methods of use consistent with the intended music compilation systems and related methods may be utilized in any implementation. This may include any materials, components, sub-components, methods, sub-methods, steps, and so forth.

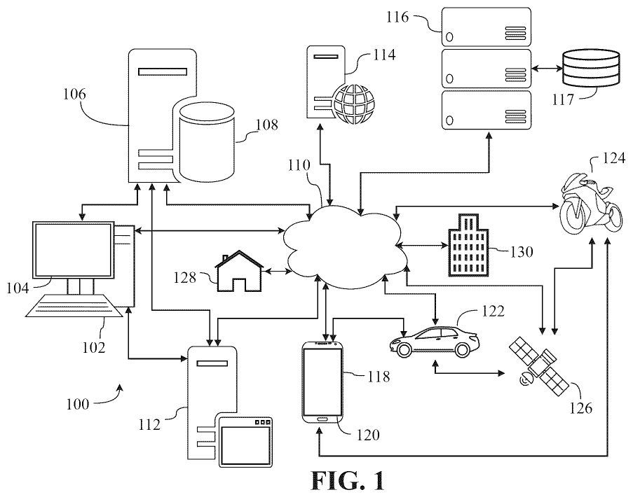

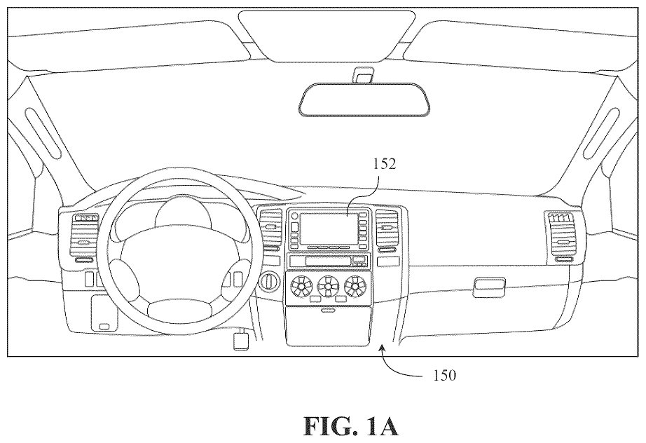

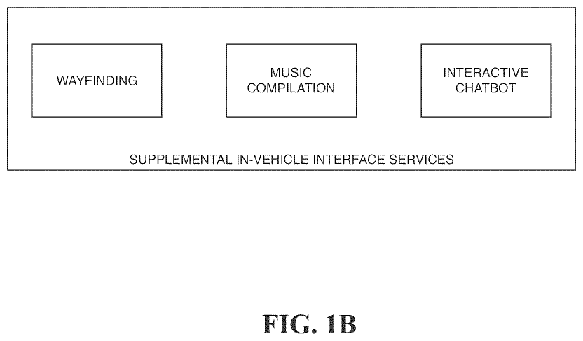

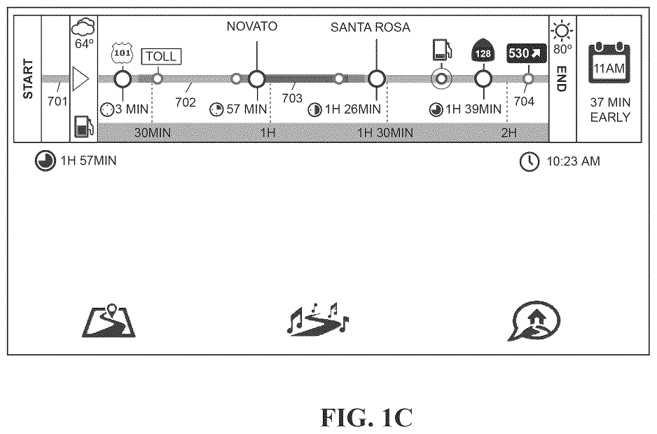

Referring now to FIG. 1, a representative implementation of a music compilation system (system) 100 is shown. Other music compilation systems may include additional elements and/or may exclude some elements of system 100, but some representative example elements of system 100 are shown. Computing device (device) 102 includes a display 104 through which an administrator may access various elements of the system using a variety of user interfaces. Device 102 is seen communicatively coupled with a database server (DB server) 106 which in turn is communicatively coupled with a database (DB) 108. The administrator may configure one or more databases and one or more database servers for storing various data used in conjunction with the methods disclosed herein.

The administrator device 102 may be directly communicatively coupled with the database server or could be coupled thereto through a telecommunications network 110 such as, by non-limiting example, the Internet. The admin and/or travelers (end users) could access elements of the system through one or more software applications on a computer, smart phone (such as device 118 having display 120), tablet, and so forth, such as through one or more application servers 112. The admin and/or end users could also access elements of the system through one or more websites, such as through one or more web servers 114. The system also communicates with third-party servers 116 (which in turn may be in communication with third-party databases 117) to implement the music compilation. One or more off-site or remote/cloud servers/databases could be used for any of the server and/or storage elements of the system.

In implementations one or more vehicles may be communicatively coupled with other elements of the system, such as vehicles 122 and 124. Vehicle 122 is illustrated as a car and vehicle 124 as a motorcycle but representatively illustrate that any vehicle (car, truck, SUV, van, motorcycle, etc.) could be used with the system so long as the vehicle has a visual and/or audio interface and/or has communicative abilities through the telecommunications network through which a traveler may access elements of the system. For example, the vehicle may have a BLUETOOTH connectivity with device 118, and through this connectivity any of the vehicle's sensors, such as temperature, global positioning satellite (GPS), and so forth, may be used by the system to implement music compilation methods. Additionally, if the vehicle has connectivity with the Internet, the device 118 may communicate with any other elements of the system through the vehicle's connection. This could be useful, by non-limiting example, when a driver is in a location without cell phone tower coverage but the vehicle still has connectivity to the Internet, such as through satellite communications. A representative satellite 126 is shown communicatively coupled with the vehicles, although the satellite may rightly be understood to be comprised in the telecommunications network 110—the standalone satellite is shown only to emphasize that the vehicles may communicate with the system even when in a place without access to Wi-Fi and/or cell towers (and when in proximity of Wi-Fi and/or cell towers may also communicate through Wi-Fi and cellular networks) and, as indicated above, the device 118 may utilize this connectivity in order to implement music compilation methods. System 100 also shows a home 128 and an office 130 communicatively coupled with the system through the telecommunications network. These are meant to represent that the system may use inputs from these locations (for example smart appliances, smart thermostats, smart speakers, and so forth) in the home, at an office, at a school, at a gym, and at any other location to inform the system in determining a proper music compilation in any given situation.

The system 100 is illustrated in an intentionally simplified manner and only as a representative example. One or more of the servers, databases, etc. could be combined onto a single computing device for a very simplified version of system 100, and on the other hand the system may be scaled up by including any number of each type of server and other element so that the system may easily serve thousands, millions, and even billions of concurrent users/travelers/vehicles. While only one device 118 is shown, in some implementations there would normally be many devices 118 accessing the system and implementing the methods simultaneously, with the number of databases, servers, computing devices, and the like scaled up to accommodate the number of users.

The system may, after receiving permission using device 118 when installing a software application to implement music compilation, access the user's online calendar application, which may be useful to help know how to compile the music. For example the system may at one point determine, using the user's third-party calendar, that the user is driving to an important meeting with a coworker, and at another point may determine that the user is having dinner at home with a friend, and may use this information to tailor different music compilations appropriate for each setting.

The system may also, with the user's permission, access the user's PANDORA music profile, the user's SPOTIFY profile, and any number of other music streaming service profiles to help implement the music compilation by providing music, listening history, preferences, and other profile information from those applications. User login information for third-party music applications (and any other third-party software applications) may be stored in the database(s) so that the system may access the third-party applications using the user's profile to provide the music compilation services. SONOS is an example of an existing system/method which allows playback from multiple existing streaming audio accounts, though without many of the features described herein with respect to the disclosed systems/methods.

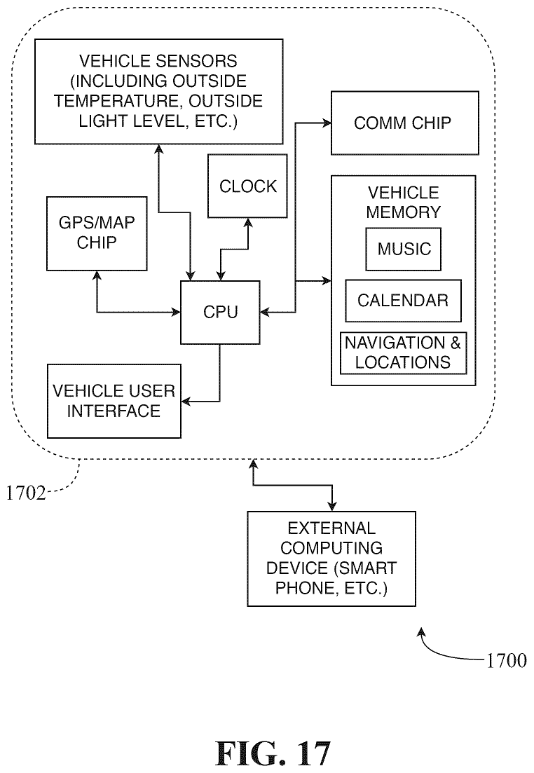

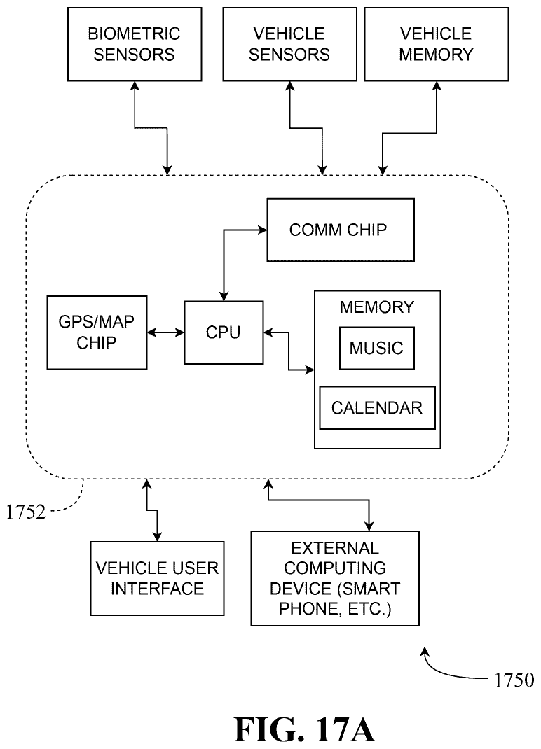

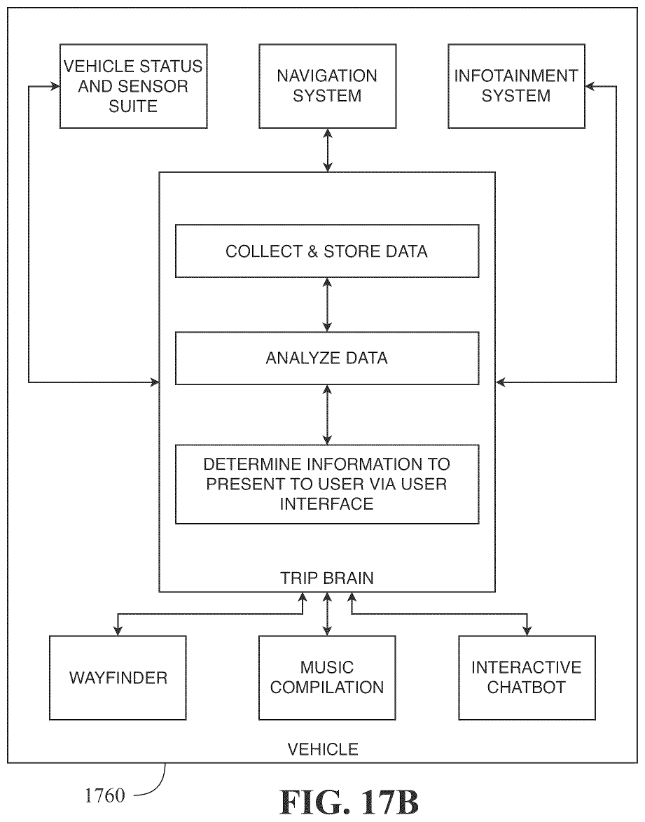

When the user is in a vehicle, the system may also access a vehicle memory and/or other elements. FIG. 17 includes a block diagram (diagram) 1700 representatively illustrating a vehicle system 1702 communicatively coupled with an external computing device, which may be device 118 by non-limiting example. The vehicle system is seen to include a processor (CPU), a user interface, a GPS/MAP chip, a communications (COMM) chip, and vehicle memory. It can be seen that some music files, navigation history and stored locations are stored in the vehicle memory, and that the vehicle has a built-in calendar (which may in turn be syncing from the user's third-party calendar such as a Samsung Calendar or the like). The CPU is also seen to be communicatively coupled with vehicle sensors, including outside temperature sensors, ambient light sensors, biometric sensors, and other sensors. The CPU is also coupled with a clock which may obtain time information from satellites and the like. The ability of the system to access the vehicle elements may at times be useful to help compile a proper music compilation.

For example, from the vehicle system may be gathered (by communication of the device 118 with the vehicle system 1702, such as via a BLUETOOTH or other connection) that it is chilly and snowing outside and that there is low light (through vehicle sensors), that the user is on a mountainous backroad (through the GPS/MAP chip), that the user is driving an SUV with the four-wheel drive enabled (through the vehicle sensors and/or memory), and that the user is heading to a cabin for the weekend with family (through the calendar). This information could all inform the system 100 in compiling an appropriate music compilation which takes into account the need of the user to drive slowly and carefully, due to the weather and road conditions, but also help the user and passengers to wind down for a relaxing weekend. The music compilation could include some music that is stored in the vehicle memory as well as other music that is streamed from third-party applications.

The above vehicle-based example is only one example, as the system 100 may be used to compile music in any non-driving setting, and in such implementations there may be no vehicle involved and accordingly no vehicle system involved. But the above is only given as a representative example of how, when the user is in a vehicle, the system may utilize the vehicle system 1702 to further inform the music compilation. Additionally, when the user is in a vehicle the system 100 may play the music compilation through the vehicle's sound system (and/or display the music details on the vehicle user interface), such as by communicating the data from the device 118 to the vehicle system through a wireless or wired connection.

Referring now to FIG. 17A, the system 100 may also include elements located within or coupled directly with a vehicle. For example, block diagram 1750 shows a representative example of a Trip Brain 1752 which includes a central processing unit (CPU), a GPS or map chip, a communications (COMM) chip, and on-board memory. These elements could all be coupled on a single printed circuit board (PCB) and located within the dashboard (or elsewhere on/in the vehicle) communicatively coupled with the display 152 and with the vehicle's audio elements (speakers and microphone, not shown) and biometric sensors which together comprise the vehicle user interface. The Trip Brain may receive input from the vehicle user interface through voice or audio commands, physical button/selector/knob inputs, touchscreen inputs, and so forth. The Trip Brain may send data to the vehicle user interface for visual display and/or audio output to the traveler. A traveler's external computing device (smart phone, laptop, tablet, etc.) may also send data to, and receive data from, the Trip Brain in like manner over wireless signals such as through Wi-Fi, cellular, BLUETOOTH, or the like using the communications chip.

The communications chip (which in implementations may actually be multiple chips to communicate through Wi-Fi, BLUETOOTH, cellular, near field communications, and a variety of other communication types) may be used to access data stored outside of system 100, for example the user's GOOGLE calendar, the user's PANDORA music profile, and so forth. The communications chip may also be used to access data stored within the system database(s) (which may include data from an external calendar, an external music service, and a variety of other elements/applications that have been stored in the system database(s)). Local memory of the Trip Brain, however, may also store some of this information permanently and/or temporarily.

The Trip Brain is also seen to be able to access information from the vehicle sensors and the vehicle memory. In implementations the Trip Brain only receives data/information from these and does not send information to them (other than queries) or store information therein, but as data queries may in implementations be made to them (and to a vehicle navigation system) the arrow connectors between these elements and the Trip Brain in FIGS. 17A-17B are illustrated as two-way connectors. Similarly, as the Trip Brain may receive input from users through one or more Wayfinder interfaces, one or more Music Compilation interfaces, and or through user interaction with the Interactive Chatbot, as will be discussed more below, the arrows connecting those elements with the Trip Brain in FIG. 17B are also shown as two-way connectors.

The Trip Brain may include other connections or communicative couplings between elements, and may include additional elements/components or fewer components/elements. Diagram 1750 only shows one representative example of a Trip Brain and its connections/communicative couplings with other elements. In some implementations some processing of information could be done remote from the vehicle, for example using an application server or other server of system 100, so that the Trip Brain is mostly used only to receive and deliver communications to/from the traveler. In other implementations the Trip Brain may include greater processing power and/or memory/storage for quicker and local processing of information and the role of external servers and the like of system 100 may be reduced.

Referring now to FIG. 17B, block diagram 1760 representatively illustrates in more detail the functionality of the Trip Brain. This functionality includes, in implementations, data collection, analysis, and management. The Trip Brain allows for every kind of trip to be its own unique type of experience determined by the specific qualities of the trip. By non-limiting example, in implementations there are six major contextual qualities that may define a trip, and the Trip Brain may, using user input (directly acquired from user input and/or passively acquired by system listening, including through biometric, speech, facial recognition and other sensors) and/or acquired by the system accessing information externally (such as through Internet information sources, GPS data, and so forth), structure the experience accordingly. In such implementations the six qualities are:
(1) Trip progression: How will the drive evolve? How long will the trip be? What kinds of roads will be driven on and will the type of road change (i.e., from city to highway)? Will there be traffic jams? Toll roads, etc.
(2) Intent, the purpose of the trip: Is it a commute, an errand, a trip to a meeting, a road trip?
(3) The social dynamic within the cabin: Is the driver alone, traveling with family, with friends, with weak social connections? The driver's experience will be dramatically different depending on the context.
(4) The driver's or traveler's state of mind: Is the driver reflective? Frustrated? Does she/he/they need to reboot their brain?
(5) The trip conditions: What is the weather like outside? What is the time of day? What are the speeds of travel?
(6) Regularity of the trip: Is the trip part of a larger pattern? Is it a recurring, even regular trip? Is there a time and/or day of week (e.g., only on Saturdays) pattern to it? Are there certain behaviors associated with this particular route, like stopping for a coffee or gas? Are routine choices being made?

FIG. 17B shows the navigation system existing outside of the Trip Brain, and indeed this is an option different than what was presented in FIG. 17A. The vehicle may already have its own GPS chip and/or navigation system, and the Trip Brain may simply communicate with the existing navigation system as shown in FIG. 17B.

FIG. 17B also shows that the Trip Brain collects and stores data. In implementations the information provided by the car's sensors and other vehicle information is accumulated over time by the Trip Brain in order to assess the aforementioned qualities of context. This data input is precise and manageable as it is derived only from concrete sources available to the car system. For example, in the example of FIG. 17B a navigation application is already able to present the last destination entered, store destinations, and so on. The Trip Brain, however, also combines, tracks and analyzes the information so that it can learn and adjust based on previous behavior and so that the same information can be used in other services and applications, not only in the app from which it was sourced. In other words, the accumulated data collected is shared among various applications and services instead of being isolated. The storage half of “Collect & Store” may include storage in local memory and/or storage remotely, by accessing storage elements communicatively coupled with the Trip Brain through the telecommunications network.

FIG. 17B also shows that the Trip Brain does data analysis. Each trip may contain data from various sources including the vehicle's sensors and other vehicle information, the navigation application, the infotainment system, connected external devices (laptop, smart phone, etc.), and so on. The Trip Brain synthesizes the information in order to make inferences about the qualities of context that define a trip.

In implementations the trip progression can be derived from the navigation system.

In implementations intent can be derived by analyzing the cumulative historical information collected from the navigation system (e.g., the number of times a particular destination was used, the times of day of travel, and the vehicle occupants during those trips) as well as the traveler's calendar entries and other accessible information.

In implementations the social dynamic in the car can be deduced by the navigation (e.g., type of destination), the vehicle's voice and face recognition sensors, biometric sensors, the infotainment selection or lack thereof, the types and quantity of near field communication (NFC) objects recognized (e.g., office keycards), and so on.

In implementations the occupants' state of mind can be determined via the vehicle's biometric, voice and face recognition sensors, the usage of the climate control system (e.g., heat), infotainment selection or lack thereof, and so on. For example, a driver of the vehicle may be in a bad mood (as determined by gripping the steering wheel harder than usual and their tone of voice, use of language, or use of climate control system) and may be accelerating too quickly or driving at a high speed. The system may be configured to provide appropriate feedback to the driver responsive to such events.

In implementations the road conditions can be sourced through the car's information and monitoring system (e.g., speedometer, external sensors, weather app, the navigation system and the Wayfinder service, which will be explained in detail below).

In implementations regularity of the trip can be determined through cumulative historical navigation data, calendar patterns, and external devices that may be recognized by the vehicle (e.g., personal computer).

In implementations the Trip Brain analyzes each data point relating to a particular trip and provides direction for the Wayfinder, Music Compilation, and Interactive Chatbot features. These features are implemented through the one or more vehicle user interfaces (presentation layer) in a way that is cohesive, intuitive and easy to understand and use. In implementations (as in FIG. 17B) the Trip Brain may interact with an existing infotainment system present in a vehicle, such as by non-limiting example by obtaining information and/or entertainment material through the infotainment system to present to the travelers through the AI Sidekick or otherwise. As an example the Trip Brain may obtain from the infotainment system a list of news stories, pop-culture events, and so forth and the Interactive Chatbot may present these to the travelers and ask if they are interested in knowing more about any given one, and if so may proceed to give more information related thereto.

In implementations the Trip Brain and the system 100 architecture are based on system design thinking rather than just user design thinking. As a result, it offers a comprehensive service that is not only designed for individual actions, but considers the entire experience as a coherent service that considers each action as part of the whole. Consider, for example, the audio aspect of infotainment. One possible alternative to streaming music sequentially is to render it in a manner similar to a DJ mix: having a beginning, a middle, and an end, and sometimes playing only parts of songs instead of complete tracks. The characteristics of the mix (e.g., sentiment) may be based on the attributes of the trip (e.g., intent). To accomplish this the Trip Brain may acquire and store information from the vehicle navigation system to let the music app know, via the Trip Brain, the context associated with the trip such as duration, intent, social dynamic, road conditions and so on. If the Trip Brain has information from the navigation system and calendar indicating the driver of the vehicle is heading to a business meeting at a new location, the vehicle interface system can, using the Interactive Chatbot, prompt the driver fifteen minutes before arrival and provide the driver with the meeting participants' bios to orient the driver for the visit.

As indicated by FIGS. 17A-17B, in implementations there is a symbiotic connectivity between the different vehicle systems through the Trip Brain. For example, the Trip Brain may receive input from the vehicle navigation system, infotainment system (music/telematics), car sensors, a calendar or planner associated with a user of the vehicle that may be a part of the infotainment system, outside sources (like a smart phone), and other vehicle information such as type of vehicle, weight, and so forth, all managed and interpreted by the Trip Brain and turned into actionable directives for the Wayfinder, Music Compilation, and Interactive Chatbot services, and delivered to the user through one or more user interfaces.

The system and methods provide an intelligent in-vehicle experience that supplements the existing vehicle features. The intelligent in-vehicle experience is based on data collection, analysis, and management and integrates the different components of the driver-vehicle interface. The Wayfinder, Music Compilation, and Interactive Chatbot features, discussed further below, are presented to the driver in a cohesive, intuitive format that is easy to understand and use. This intelligent vehicle experience may in implementations (and herein may) be referred to as “TRIP.” The Trip Brain reads inputs from the car's navigation application and other input sources such as weather, calendar, etc. that are configured to provide location coordinates and other trip-related information to the vehicle interface. This information is used by the Trip Brain to direct Wayfinding, Music Compilation, and Interactive Chatbot (wellbeing and productivity) functions.

In implementations the system 100 implements the music compilation in a way that it is noticeably different from conventional music streaming services, so that the music compilation is a DJ-like compilation. This may return music listening in the vehicle to something more like an art form. In implementations the music compilation could be prepared for a specific trip (or in other words the system selects songs and portions of songs for a soundtrack based on the details of a specific drive). The system may adaptively mix music tracks and partial music tracks in a way that adjusts to the nature and details of the trip, instead of playing music tracks in a linear, sequential yet random fashion as with conventional music streaming services. The system may implement music compilation by mixing tracks and partial tracks that are determined by the system to be appropriate for the current trip, the current stage of the trip, and so forth.

But, as indicated above, the system and methods disclosed herein are not only for trips, and not only for driving. The system and methods may be used to mix music tracks and/or partial tracks of third-party catalogs in an adaptive manner based on the particular listening occasion, in any type of setting. For instance, the system and method could be used in an art studio setting, playing background music for the artists, while they create their art. The mixing may be done in a professional, DJ-like manner so that the sequence of tracks and/or partial tracks appear as one continuous and seamless track.

Referring now to FIG. 1A, a representative example of a vehicle dashboard (dashboard) 150 is shown, on which a display 152 is located. On a display such as this various user interfaces, enabled by the system 100, may be shown to a traveler, and may be used for visual communications to and from the traveler. In-vehicle audio elements, such as a vehicle microphone to receive user audio input and speakers to communicate and/or provide sound to the user, may also provide user communication with elements of system 100.

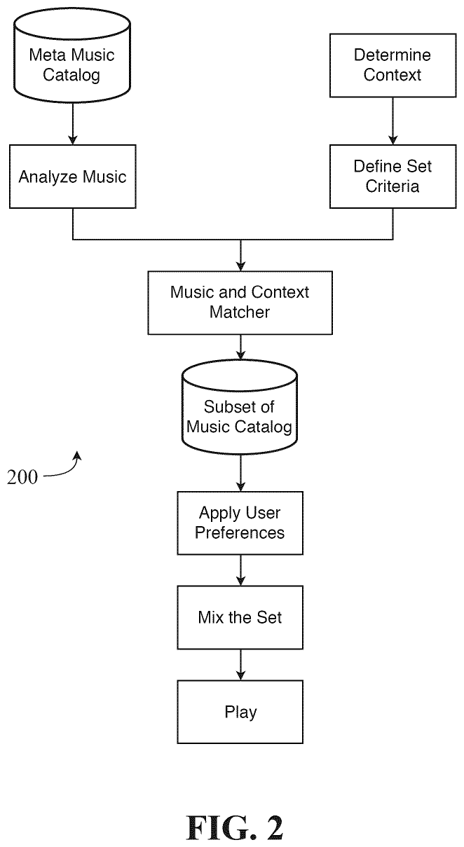

Referring now to FIG. 2, block diagram (diagram) 200 representatively illustrates details of the system 100 and music compilation methods. As discussed briefly above, in implementations the system and method utilizes third-party music streaming services and personal music libraries, such as by accessing the user's music catalogs (such as from servers of the system 100 accessing third-party servers 116) using third-party application program interfaces (APIs). For example, referring back to FIG. 1, the system may communicate with one or more SPOTIFY servers (third-party servers 116) which in turn communicate with SPOTIFY databases (third-party databases 117). The communication of the system 100 with the third-party servers may be done using the third-party's API. Using such communication the system may obtain details of the user's SPOTIFY music catalog and playlists, which could include for example which stations the user has set up, which tracks the user has given a “thumbs up” to, which tracks the user has given a “thumbs down” to, a list of recently played tracks, and so forth. The information for the tracks could include artist, song, album, album artwork, and so forth. The system may store all or some of this information in the database(s) 108. The user login credentials for the SPOTIFY service may have previously been stored in the database through a user interface (such as on a mobile device app).

The system 100 in implementations may not store the actual music files themselves, but may simply stream some or all of them from the third-party music application. For example, if the user is a paid or premium user of SPOTIFY the user can select and play any song on demand, and the system 100 can use this ability in behalf of the user to select and play a series of songs. But in implementations third-party music applications do allow downloading of music for offline playing, and in implementations the system 100 may download the tracks selected for a compiled set of music (and in some implementations may delete them later, so that they are only stored temporarily to implement the set). The downloading of the tracks may in implementations allow the system to more easily transition from one track to another using DJ-like effects, which will be discussed hereafter. However, in implementations a music streaming service without download privileges may still allow loading of multiple songs to transitory storage ahead of time, and based on this functionality the system 100 may still be able to transition tracks with DJ-like effects.

The above example of a SPOTIFY library is given, but the user may have a catalog for any number of music streaming services, such as SHAZAM, PANDORA, IHEARTRADIO, LIVEXLIVE, TUNEIN, SOUND CLOUD, GOOGLE PLAY MUSIC, MUSI, PLAYLIST, 8TRACKS, SPINRILLA, APPLE MUSIC, SIRIUS XM, TIDAL, AMAZON MUSIC, NAPSTER, DEEZER, and so forth. The system 100 may, using the user's login credentials and/or permissions as supplied by the user, access catalogs and profile information for all of the user's streaming music services. Similarly, any songs that the user actually owns, such as a library of purchased songs available through APPLE MUSIC, GOOGLE PLAY MUSIC, AMAZON MUSIC, or songs owned and downloaded to the device 118 through any service, may be used by the system 100 to determine a meta music catalog, as indicated on FIG. 2. As previously stated, this collection of songs may simply indicate the details about the songs, such as artist, album, and song title, album art, and so forth, but may in implementations not include the music files themselves. The meta music catalog is therefore a collection of information about the user's music listening, including individual songs listened to, songs liked, songs disliked, etc., from various streaming services and downloaded music files.

FIG. 2 shows an analyze music step. In order to compile music sets, all songs within the meta music catalog are analyzed, categorized and indexed according to a proprietary music analysis algorithm which identifies each song's tempo, approachability, engagement, and sentiment. This index may be stored in the database and associated with the specific user through the database. In parallel, sensors and applications communicating with the system 100 (such as calendar and navigation applications on the device 118 to which the user has allowed system 100 to access) and other information allow the system 100 to determine the specific context or occasion for the music listening experience. The identification of the context allows the system to determine requirements for the music mix set to be compiled. In other words, the context determines the criteria for the appropriate music to be mixed. As such, the criteria change with each particular context.

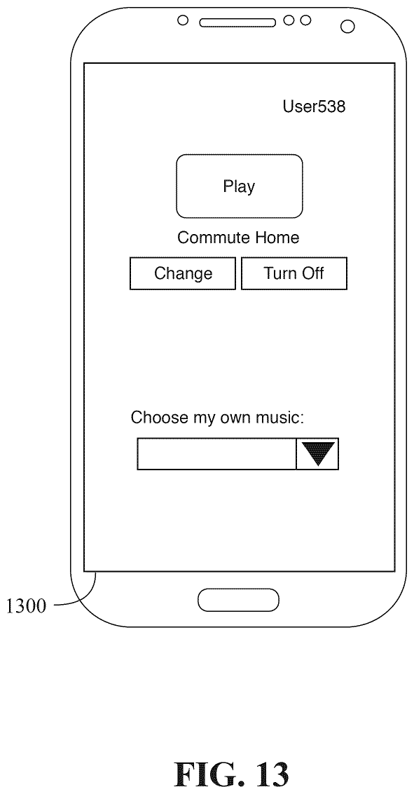

The defined music set criteria and analysis information related to the meta music catalog are then matched to filter the meta music catalog and collect only the qualifying songs that match the criteria for the specific listening occasion. In this way, a “set catalog” is formed (shown in FIG. 2 as “subset of music catalog”). The set catalog can be further filtered by user preferences. For instance, there may be certain genres or artists that should not be played (either never, or only during certain occasions: e.g., “do not play punk music when my wife is in the car”). These preferences then further limit the set catalog. This is shown in FIG. 2 by the “apply user preferences” step. A virtual DJ “turntabler” engine then configures the seamless mix-set that takes into account a possible time frame and vibe progression. In implementations all the user has to do is select a “play” selector (for example the play selector representatively illustrated in FIG. 13) and the set will automatically begin without further commands.

With regards to the meta music catalog, the system may use various music libraries to create mixes that retain the nuanced skills and rules to make a befitting soundtrack for each particular situation. Two existing examples of music libraries are: a personal library that may be locally stored to a device and a library from a music streaming service such as SPOTIFY. Unlike other existing services such as the SONOS application, which lists and provides access to individual libraries, but does not actually aggregate music libraries, the system 100 combines the user's available libraries into one meta music library from which to create mixes. This approach deliberately foregoes a direct relationship with the music industry, and instead utilizes the APIs of streaming services and access to personal libraries. And instead of simply playing songs from third-party catalogs, the system 100 modifies and mixes each song, thereby creating a distinctive, new music listening experience. In a sense, the system 100 is creating a new music format: the automated radio mix-set.

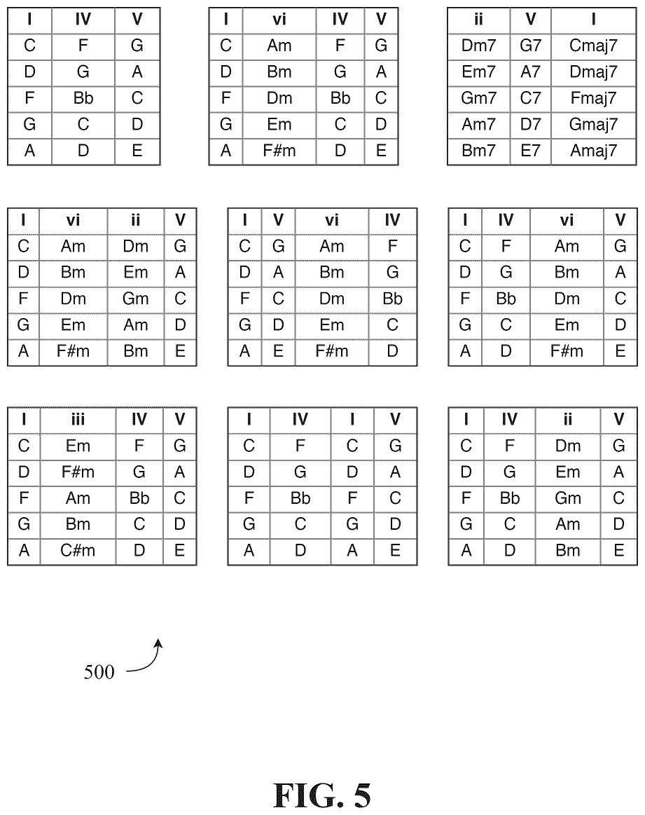

Referring now to FIG. 1B, block diagram representatively illustrates that, in some implementations, the functionality of the system 100 and/or Trip Brain may be broadly organized into three categories: Wayfinding (which is more than mere navigational mapping, and which may be referred to as “Wayfinder”); DJ-like Music Compilation (which may be referred to as “Soundtrack”); and an artificial intelligence (AI) Interactive Chatbot (which may be referred to as “Sanctuary”). These services are distinct from what exists in current vehicle systems, and are accordingly designated “supplemental” in FIG. 5. Each of these functions may be used discretely in implementations, and in implementations they may all also be interconnected.

In implementations the Wayfinding, Music Compilation, and Interactive Chatbot experience allow the car cabin to function as a unique “in-between” or “task-negative” space (as opposed to an on-task space such as the workplace or the home) that lets travelers' minds wander, helps them emotionally reset, and serves as a sanctuary and a place of refuge. The Wayfinding, Music Compilation, and Interactive Chatbot features will be discussed in more detail below.

### Wayfinding Service

The Wayfinding service (Wayfinder) may be implemented using one or more user interfaces that are displayed on display 152, but is more than a navigational map. While conventional navigational maps serve the driver operating a car with route selection, turn-by-turn directions and distances (e.g., number of miles to the next turn), the Wayfinder serves the passenger's trip-related orientation and activities for life outside the car. It exists to help people along a drive, enhance their understanding and enrich their experience of the route and destination. Additionally, the Wayfinding service provides flexibility in the visual presentation and organization of the map, allowing for infographic (or more infographic) as opposed to cartographic (or primarily cartographic) presentation. For example, in implementations distracting and static street grid elements are removed.

In implementations the Wayfinding service may focus more on showing the user's traveling times or time ranges, as opposed to distances, involved in a given route. In these ways, the Wayfinding service conveys trip information in a way that is easier to understand (e.g., time instead of distance) and uses a design element herein termed “Responsive Filtering,” in that information not pertinent to a passenger's question at hand (i.e., miles, street grid layout, etc.) are removed to avoid overload.

FIG. 1C shows a representative example of an interface of the system 100, which in implementations may be called the Tracker or Trip Tracker. This interface may be shown on display 152 and may in implementations show a summary of the trip at hand. The summary is visually displayed in a way that a short glance gives the user an updated sense of the trip, relative to his/her current location along the route.

The Trip Tracker interface in implementations includes selectors that are selectable to expand (to provide further detail) and/or to navigate to other windows/interfaces. As seen in FIG. 1C, the bottom of the infographic display presents three icons. The leftmost icon is an icon that initiates the Wayfinder service. The middle icon is associated with the Music Compilation service (discussed subsequently) called Soundtrack, and the rightmost icon represents the Interactive Chatbot, which may be called Sanctuary.

### Music Compilation Service (Soundtrack)

Referring to FIG. 1C, in implementations a user may select the Music Compilation icon at the bottom center of the screen to initiate the Music Compilation service. Selecting this selector may start playing music directly, but in implementations it may also bring up one or more user interfaces which show details of the Music Compilation—such as currently playing song, next song, selectors to pause/skip/fast-forward/rewind, and so forth. In implementations when a user selects the Music Compilation icon from the interface of FIG. 1C the details of the Music Compilation may simply appear or be shown within the interface of FIG. 1C itself, such as below the trip information at the top of the interface, though in other implementations there may be a separate Music Compilation interface that is brought up when the user selects the Music Compilation icon and then the user may revert back to the interface of FIG. 1C by selecting a selector on the Music Compilation interface (or the system may be set to automatically revert to the interface of FIG. 1C after no user interaction has been received by a predetermined amount of time, such as a few minutes).

In implementations the system implements the Music Compilation service in a way that it is noticeably different from conventional music streaming services, so that the Music Compilation is a DJ-like compilation. This may return music listening in the vehicle to something more like an art form. In implementations the Music Compilation service creates a soundtrack for the trip (or in other words selects songs and portions of songs for a soundtrack) based on the details of the drive. The Music Complication service (which may be called Soundtrack) may be implemented using the Trip Brain, though some portions of the implementation may be done using one or more servers and/or databases of the system and/or in conjunction with third-party APIs (such as accessing music available through the user's license/profile from one or more third-party music libraries) and such. In implementations the Music Compilation service is implemented by the Trip Brain adaptively mixing music tracks and partial music tracks in a way that adjusts to the nature and details of the trip, instead of playing music tracks in a linear, sequential yet random fashion as with conventional music streaming services. The Trip Brain in implementations implements the Music Compilation service by instead mixing tracks and partial tracks that are determined by the Trip Brain to be appropriate for the current trip, the current stage of the trip, and so forth.

### AI Sidekick/Interactive Chatbot

DJ: In conjunction with the Music Compilation service, the AI Sidekick may be configured to present a curated Music Compilation for the driver's entertainment. This compilation may be from a streaming music source or from a private music catalog associated with the vehicle occupant(s). The AI Sidekick may also have other functionalities, as described in one or more of the Parent applications.

### Music Compilation Methods

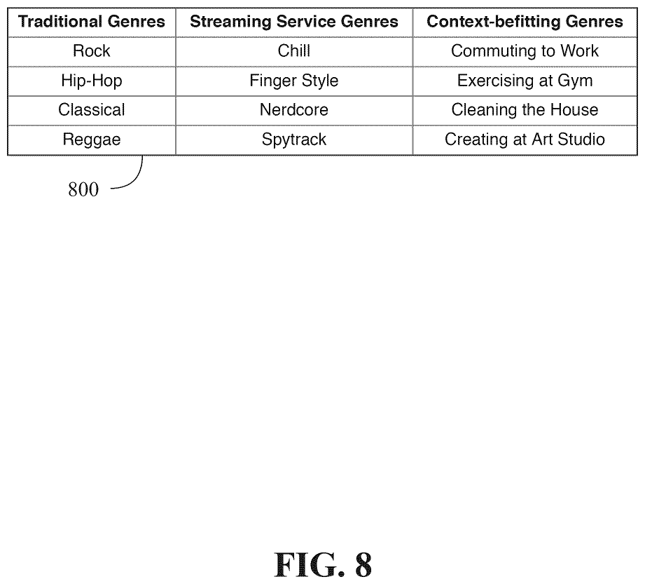

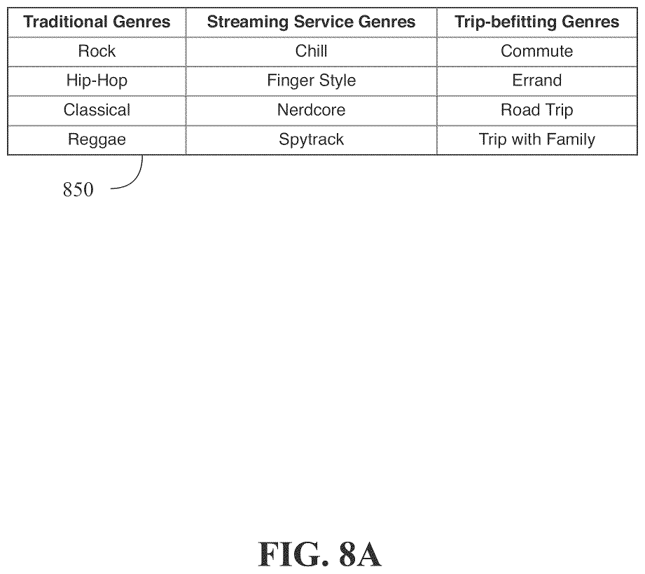

In implementations a Music Compilation method implemented by the system includes a step of classifying music tracks and/or partial tracks not according to music style (or not only according to music style), but according to the context of a trip. A representative example is given in table 850 of FIG. 8A, wherein trip contexts of commuting to work, errand, road trip, and trip with family are given. In other implementations there may be fewer or more trip contexts, such as: commute to work, commute from work, doing taxiing work (such as through LYFT or UBER), late night return home, and so forth. Table 850 compares the trip-befitting genres with lists of categories that might be used in conventional streaming services, such as traditional genres of rock, hip-hop, classical and reggae, or streaming service genres of chill, finger-style, nerdcore and spytrack. The Music Compilation method may use track and portions of tracks from these and any other genres, but weaves them into a compilation that is fitting for a given trip.

In implementations the Music Compilation method includes analyzing each song by multiple criteria.

Accordingly, in implementations, instead of dividing a music catalog into traditional genres or streaming service genres, the Music Compilation service organizes the music catalog according to what type of drive (like commute to work or errand) and social dynamic a song is appropriate for. As an example, a traveler will listen to different music if alone in the car versus driving with a 9-year old daughter or versus traveling with a business contact who may be classified as a weak social connection. In this sense, the Music Compilation service (in other words, the Music Compilation method) is done in a context-aware and trip-befitting manner.

This type of Music Compilation in implementations results in playlists that are not necessarily linear, or in other words the songs in the playlist are not necessarily similar to one another. Additionally, the method may exclude random selection of songs (or random selection within a given category) but is much more curated to fit the conditions of the trip and/or the mood of the occupants. In this way the method includes effectively creating a DJ set, utilizing the nuanced skills and rules that make a soundtrack befitting for a particular journey. This includes, in implementations, selecting an optimal song order for a drive including when to bring the vibe up, when to subtly let the mood drop, when to bring the music to the forefront, when to switch it to the background, when to calm, when to energize, and so forth. The Trip Brain and/or other elements of the system may determine, based on the trip details, how long the set needs to be, appropriate moods, appropriate times to switch the mood, and so forth.

The Music Compilation methods may also include, at times, using only samples of songs instead of only full tracks. In short, the Music Compilation methods may utilize professional DJ rules and DJ mix techniques to ensure each soundtrack or set enhances a traveler's mood.

Accordingly, the systems and methods may analyze the tempo, approachability, engagement, and sentiment of each track based on an analysis of the subcategories, described herein, for each track. In implementations fewer or more categories (and/or fewer or more subcategories) may be used in making such an analysis. This analysis could be done at the Trip Brain level or it could be done higher up the system by the servers and databases—for example one or more of the servers could be tasked with “listening” to songs in an ongoing manner and adding scores or metrics in a database for each track, so that when a user is on a drive the system already has a large store of categorized tracks to select from. Alternatively or additionally, the Trip Brain may be able to perform such an analysis in-situ so that new tracks not categorized may be “listened” to by the Trip Brain (or by servers communicating with the Trip Brain) during a given trip and a determination made as whether to add it to, and where to add it to, an existing trip playlist so that it is then played audibly (in full or in part) for the user. Various scoring mechanisms could be used in categorizations. For example, with regards to engagement each sub-category could be given equal weight. This could be done by assigning a score of 0-20 to each sub-category, so that a song with maximum dynamics, pan effect, harmony complexity, vocabulary range and word count would be given a score of 20+20+20+20+20=100 for engagement (i.e., fully lean-forward). In other implementations some sub-categories could be given greater weight than other sub-categories, and in general various scoring mechanisms could be used to determine an overall level for each main category.

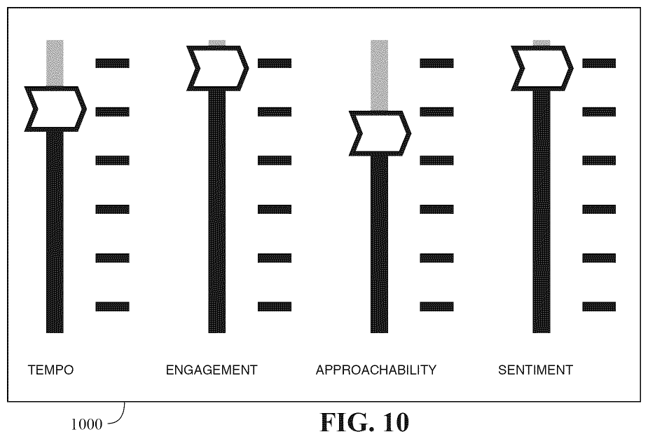

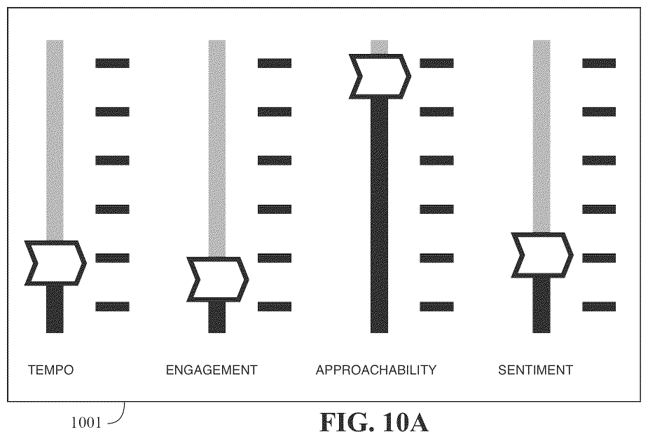

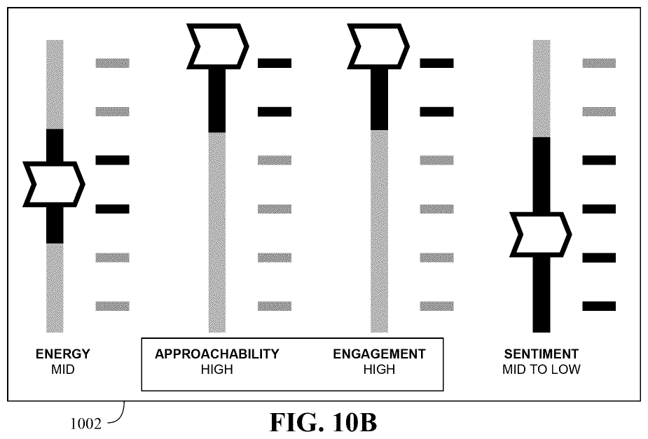

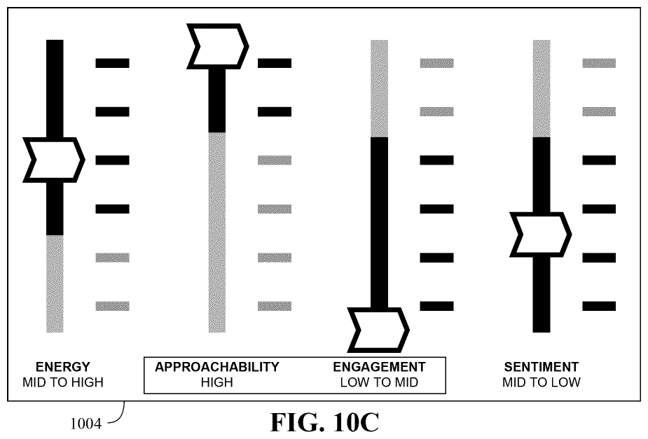

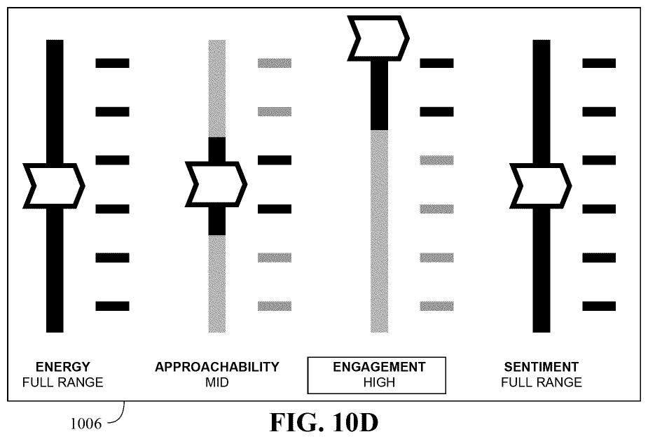

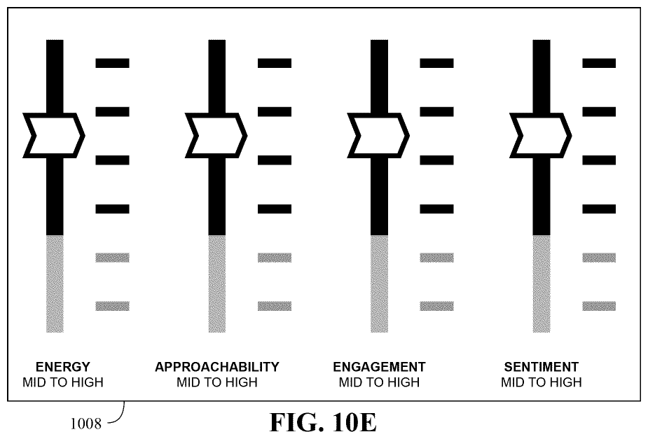

The system may select an internal setting for the music. This is representatively illustrated by diagram 1001 of FIG. 10A, which representatively illustrates a level for each setting so that tempo, engagement, and sentiment are set to low levels while approachability is set to a very high level. FIG. 10A only representatively illustrates, however, what is happening internal to the system—the user may never actually see such a diagram indicating the settings chosen by the system.

It will be pointed out here that various methods may be used to determine how many people, and which specific people, are in the cabin in order to help determine appropriate levels for each category. BLUETOOTH connections from the system (or Trip Brain of the system) to users' mobile phones may, as an example, indicate to the system who is present in the vehicle. The system may determine based on sound input gathered from a microphone of in-car conversations whether any given passenger is a weak, medium or strong social connection. Some such information could also be gathered by using information from social media or other accounts—for example are these two passengers FACEBOOK friends, or are they not FACEBOOK friends, but are they associated with the same company on LINKEDIN, did this trip begin by leaving a workplace in the middle of the day (i.e., more likely a trip with coworkers and/or boss and/or subordinates), did the trip begin by leaving home in the evening (i.e., more likely a trip alone or with family), and so forth. Granted, such information gathering may be considered by some to be invasive of privacy, and the systems and methods may be tailored according to the desires of a user and/or the admin according to acceptable social norms and individual comfort level to provide useful functions without an unacceptable level of privacy invasion. The system may for example have functions which may be turned on or off in a settings interface at the desire of the user.

Returning to our example of the highway trip, if there is a traffic jam the system may, upon gathering info from the vehicle navigation suite and/or communicatively connected third-party services (such as GOOGLE maps) determine that there is a traffic jam. The system may then dynamically adjust the levels so that the tempo goes up, engagement switches from low to high, and so forth to switch from more background-like music to lean-forward music in order to distract the traveler from the frustrating road conditions, and the sentiment may also appropriately switch to positive and optimistic.

In implementations the system may identify the key of each song to determine whether any two given songs would fit well next to each other in a playlist, i.e., whether they are harmonically compatible. The system could for example use a circle-of-fifths, representatively illustrated by diagram 1100 of FIG. 11, and a stored key for each song to ensure that a playlist moves around the circle and between the inner and outer wheels with every mix, progressing the soundtrack as desired and as would be done by a professional DJ.

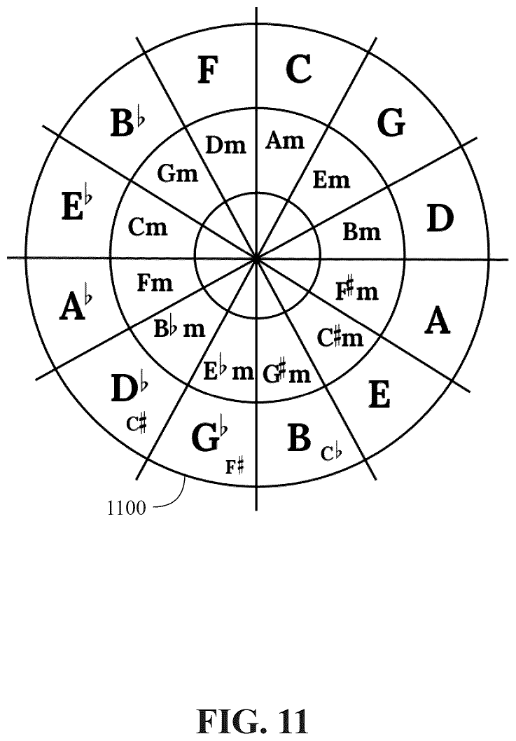

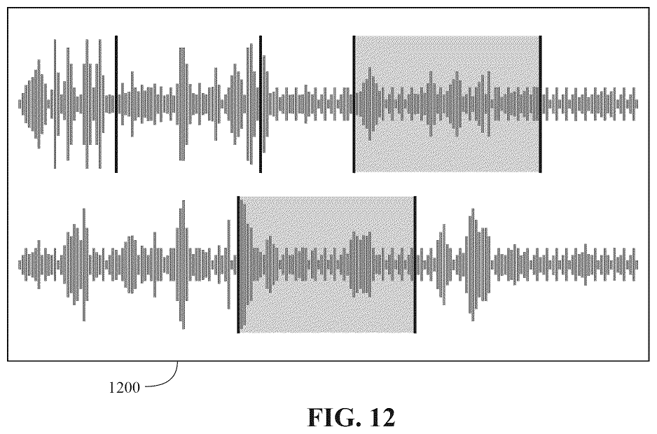

The system may also implement a cue-in feature to determine where to mix two tracks, identifying the natural breaks in each song to smoothly overlay them. Diagram 1200 of FIG. 12 representatively illustrates this, where sound profiles of a first track (top) and second track (bottom) are analyzed to determine the most likely places of each track (shown in gray) for one track to mix and switch to the other track. In such a mixing the first track may not completely finish before the second track mixes in, and similarly the second track may not be mixed in at the very beginning of the second track, but rather the tracks may be mixed in at locations of each song that would provide for the best transition between songs. The system may also use a transition technique such as fading out the first track and fading in the second track for a smoother transition.

The Music Compilation service can operate in conjunction with music libraries and music streaming services to allow travelers to shortcut the art of manually creating their own mixes, while retaining the nuanced skills and rules to make a befitting soundtrack for each particular journey. One or more algorithms associated with the Music Compilation service may be configured to curate the right mix for each drive and know when to adjust the settings either ahead of time or in-situ as situations change.

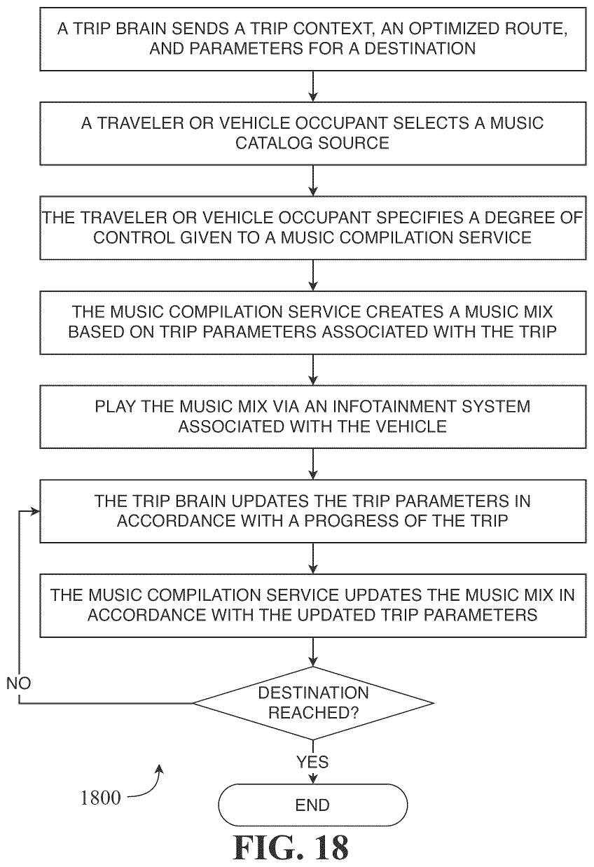

Flow diagram (flowchart) 1800 of FIG. 18 representatively illustrates a method of operation of the Music Compilation service, as carried out by the system. In implementations the Trip Brain determines the six qualities of trip context and sends an optimized route for the trip and trip parameters such as traffic and waypoints. Information about the trip may be presented to a driver of a vehicle in the form of an infographic as shown in FIG. 1C. Next, a traveler or vehicle occupant may select a music catalog source. This could for example be done by selecting from a prepopulated list of cloud-based catalog sources such as ITUNES, SPOTIFY, and/or the like which a user may input profile and login information for in order for the system to use music from those libraries to create the playlist, or the user may link some other account or library storage location to the system for this purpose. The system could also have its own default library of tracks which may be used if a user does not select a specific library or set of libraries.

The driver or a passenger specifies the amount of control given and music to be used by the Music Compilation service. This may be done using one or more inputs or selections on one or more user interfaces and/or through audio commands to the AI Sidekick. The user could for instance instruct the system to include certain songs in the playlist or to create a playlist entirely from scratch, could ask for a playlist within certain parameters such as an engaging or exciting playlist or a more chill playlist, could review the playlist before it begins and make edits to it at that point or leave it unaltered, could pause the playlist at any point along the trip, could request a song to be skipped or never played again, could ask for a song to be repeated, and so forth. Some of these settings may be edited in a settings menu to be the default settings of the Music Compilation service.

Referring still to FIG. 18, the Trip Brain creates a mix from a plurality of music tracks associated with the driver-selected music catalog(s) based on the trip parameters as determined by the Trip Brain. The Music Compilation service may play the music mix via an infotainment system associated with the vehicle (this may simply be the speakers of the vehicle playing the audio with associated track information shown on a user interface on the display of the vehicle, which user interface may also include selectors for skipping, rewinding, fast forwarding, pausing, etc.). As the trip progresses the Trip Brain updates the trip parameters in accordance with a progression of the trip, and in response the Music Compilation service may update the music mix in accordance with the updated trip parameters. For example, during a traffic jam the Music Compilation service may change its internal settings (e.g., sentiment, engagement, etc.) and revise its track selections accordingly. On an ongoing basis, the Trip Brain checks to see if the destination is reached. If the destination is not reached, the Trip Brain returns to updating the trip parameters in accordance with a progress of a trip and the Music Compilation service adjusts accordingly. If the destination is reached, the process ends. In implementations, the user may be able to save and name the soundtrack that was just played locally to the vehicle or to a remote location (e.g., database storing user information). In implementation, the user may be able to re-play a saved soundtrack through a selection on one or more of the user interfaces in the vehicle or by instructing the AI Chatbot through an audio command. In implementation, the system may add metadata to the saved soundtrack such as date played, time played (e.g., 11:04 AM until 12:56 PM), start and/or end points for the trip, and so on. In implementations, the user may be able to recall the saved soundtrack.

In implementations, the Music Compilation service may provide multiple partial soundtracks for a particular drive. Each partial soundtrack may be based on trip conditions and context, in addition to the particular preferences and characteristics of one or more travelers in the vehicle. Hence, the trip soundtrack may be controlled, in duration or partially, by the driver, as well as any of the passengers in the car.

The Music Compilation service may, in other implementations, include more or fewer steps, and in other orders than the order presented in FIG. 18.

The Music Compilation service/methods may work seamlessly with other system elements to accomplish a variety of purposes. For example, the Music Compilation service may work with the Wayfinding methods to determine how long a playlist should be, when to switch the mood (e.g., during traffic jams), and so forth. The Music Compilation service/methods could also work pauses (or volume decreases) into the playlist, such as at likely stops for gas, restroom breaks, food, and so forth when passengers may be more engaged in discussion. The system may also proactively reduce volume when conversations spark up on a given trip as determined by measuring the sound coming into a microphone of the system (which may simply be a vehicle microphone). As another example, the system may detect a baby crying in the vehicle and, in response, switch the music to soothing baby music, or music that has proven in the past to calm the baby.

In implementations the Music Compilation service could be implemented in any type of transportation setting, automobile or otherwise, but the Music Compilation service is not limited to vehicle settings. As many of the Music Compilation methods as could feasibly be implemented in a non-vehicle setting may be, such as through a streaming service implemented through a website (such as using the web server of FIG. 1), through a mobile device application (such as using the application server of FIG. 1), and so forth. In this way, the Music Compilation service could be implemented apart from and independent from any vehicle setting, but could be simply utilized as a music streaming service that incorporates the methods and characteristics described above.

For vehicle-related implementations, the practitioner of ordinary skill in the art may determine how much of the system and methods disclosed herein should be implemented using in-vehicle elements and how much should be implemented using out-of-vehicle elements (servers, databases, etc.) that are accessed by communication with the vehicle through a telecommunications network. Even in implementations which are heavily weighted towards more elements being in-vehicle, such as storing more data in memory of an in-vehicle portion of the system (such as the Trip Brain) and relying less on communication with external servers and databases, interaction with third-party services such as music libraries, weather services, information databases (for the Interactive Chatbot and infographic displays), mapping software, and the like might still rely on the in-vehicle elements communicating with out-of-vehicle elements. Storage of some elements outside of the vehicle may in implementations be more useful, while storage of others in memory of the Trip Brain may be more useful. For example, a map of local, often traversed locations may be downloaded to memory of the Trip Brain for faster navigation (and may be updated only occasionally), while a map of remote locations to which a user sometimes travels may be more conveniently stored offline in database(s) remote to the vehicle or not stored in the system at all but accessed on-demand through third-party mapping services when the system determines that a user is traveling to a location for which no map is stored in local memory of the Trip Brain. In general, the practitioner of ordinary skill can shift some processes and storage remote from the vehicle using remote servers and databases, and some processes and storage internal to the vehicle using local processors and memory of the Trip Brain, as desired for most efficient and desirable operation in any given implementation and with any given set of parameters.

Additionally, a user profile, preferences, and the like may be stored in an external database so that if the user gets in a crash the user's profile and preferences may be transferred to a new vehicle notwithstanding potential damage to the Trip Brain or other elements of the system that were in the crashed vehicle. Likewise if a user purchases or rents a second vehicle the user may be able to, using elements stored in remote databases, transfer profile and preference information to the second vehicle (even if just temporarily in the case of a rented vehicle). The system may also facilitate multiple user profiles, for example in the case of multiple persons who occasionally drive the same car, and may be configured to automatically switch between profiles based on voice detection of the identity of the current driver or occupants in the car.

Systems and methods disclosed herein may include training and implementing an empathetic artificial intelligence (AI) or machine learning (ML) model to help ensure a comfortable driving experience or state of driving. For example, referring to FIG. 1, database 108 and/or other elements of system 100 could include a back-end model and/or ML model which is trained to attempt improvements to a vehicle occupant's state of wellbeing by controlling applications such as vehicle music, a conversation agent, physical conditions (e.g., in-vehicle illumination, temperature, noise levels, humidity, etc.), and so forth. Alternatively or additionally, an ML model could be included in the memory and/or CPU element(s) of FIGS. 17 and/or 17A, within the vehicle itself, and/or within memory and/or processing elements of an external computing device (smart phone, etc.) located within or proximate the vehicle. Such an ML model may be trained, by non-limiting example, by receiving feedback from a group of travelers (or from one specific traveler) as to what elements help to improve a traveler's wellbeing in a given situation or context. Notwithstanding an ML model being trained in such a way, such an ML model may include one or more parameters or starting values, and the ML model's control of vehicle music, a conversation agent, and/or physical conditions may be kept within the parameters and/or may initially start at or include the starting values.

Such an ML model may improve in-vehicle time for a traveler, enabling great improvements in infotainment efficacy through contextual awareness due to information gathered from various sensors. While prior art infotainment options are merely for enjoyment/entertainment and information, such an ML model may help travelers drive safer and easier with less stress, more fun, and greater productivity.

According to one CONSUMER REPORTS survey, only 56% of drivers were very satisfied with their infotainment system. ML models and elements discussed herein allow for solutions to this problem, enabling a step-change in infotainment efficacy through contextual awareness, and allowing in-vehicle time to reach its full potential (or to reach much greater potential). Indeed there is much improvement that may be had. Great Britain's Office for National Statistics monitored over 60,000 drivers and used regression analysis to examine the relationship between driving and personal wellbeing. It identified how time spent driving, and method of travel, affect life satisfaction, levels of happiness and anxiety, and a sense that daily activities are worthwhile. The study found that the British spend nearly nine hour per week in a car, with each minute affecting anxiety and overall wellbeing. The study confirmed that driving (particularly commuting) is negatively associated with personal wellbeing and that, in general (for journeys of up to three hours), longer drives are worse than shorter drives for personal wellbeing. This study analyzed personal wellbeing using four measures: life satisfaction, to what extent the respondent felt the things they did in life were worthwhile, whether the drivers were happy, and whether they were anxious. A drop in the first three and a rise in anxiety was indicative of a negative effect on the person's wellbeing.

The above study effectively found that each additional minute of drive time could make a traveler feel worse. Applicant, however, has determined that travelers can derive profound personal benefit from vehicle journeys. This allows the possibility for the vehicle to act as a sanctuary. Time in the vehicle is an opportunity to release emotions a traveler wouldn't allow themselves anywhere else. It is a space where travelers can process thoughts and can feel more themselves when they step out of the car than when they got in. Indeed, people cry more in cars than in any other environment, including the home.

Neuroscientists indicate that the car is a transient, low-vigilance, in-between space, that lets our minds wander and helps us emotionally reset. It serves as a place of refuge. Neuroscientists call the car a task negative space, while other spaces like our workplace or home are on-task spaces. A joint study by HARVARD, DARTMOUTH and the UNIVERSITY OF ABERDEEN discovered that the car is a place to reboot your brain. Being a car traveler lends itself to a cognitive state termed automaticity, freeing the mind to wander. During this state, drivers reported using their travels as opportunities to let their subconscious work on complex problems and take advantage of the meditative nature of drives.

Systems and methods disclosed herein may replace a current array of disjointed software applications, alerts, and infotainment with a delightful, unifying experience. This does not necessarily involve including more software applications and features within a vehicle (or accessible from a vehicle dashboard or user interface), nor providing the largest music catalog. It may, however, involve software applications, sensor data, and other data working together (or being used together) to provide a seamless and pleasurable gestalt. This helps reduce or remove the environmental distress of trips and can help transform the car into a temporary sanctuary.

Empathetic artificial intelligence (“empathetic AI”) has been speculated (such as by a September 2020 WALL STREET JOURNAL article titled “AI's Next Act: Empathetic AI”) as being the “next big thing” and having potential to address bias and generally improve human health and happiness. The article defined empathetic AI as a combination of AI and quantifiable measures of physical and mental state to dabble in quintessentially human territory: reading a situation and addressing what really matters to people. This means interpreting clues to “sense” what a person is trying to achieve at any given moment and helping the person be successful. Empathetic AI could be used, for example, to detect our gender, age, current health, and emotional state to help us meet sleep and nutrition needs and achieve peak cognitive performance, all of which can contribute to more satisfying and healthier lives. Biometric indicators of discomfort, for example, could be used to trigger a thermostat to warm up the house a few degrees.

Systems and methods disclosed herein may utilize a variety of embedded sensors, and location data providing navigational and road condition data, to make the vehicle infotainment contextual, automated, and helpful to a traveler's wellbeing. A vehicle environment may be custom tailored to capture a variety of useful data easily, unobtrusively, and regularly to contribute to the traveler's wellbeing-much more so than the home, the workplace, or any other environment. This can include capturing biometrics, facial expression, body posture, acoustic features, linguistic patterns, and so forth. This can be used alone and/or together with location and traffic data, weather data, calendar entries (such as on a digital calendar), and vehicle on-board diagnostics. Using all of these, an emotional state can be inferred for each traveler, as well as inferring the social dynamic in a vehicle and what the intent of the drive is.

Some advancements in the hearables industry, led by BOSE and DOLBY, use biometric platforms for understanding emotional and physical states. One or more DOLBY systems/devices can detect emotions through measurable physiological changes in people. Levels of carbon dioxide in the breath, thermal imaging, LIDAR tracking of gait and movement, heart rate, pupil size, and other signatures all give off quantifiable indicators of an individual's emotional, mental, and physical state. DOLBY executives believe that people will be using headphones and earbuds to listen to their bodies more than they will listen to music. Their next-generation devices will track people's heart rates, stress levels, blood pressure, and other personal vital signs over time, giving users more input related to their health while providing doctors with valuable data for personalizing treatments and improving outcomes. Wearables, hearables, and sensors embedded in hardware such as smart speakers may soon enable other spaces and environments to offer context-based features. The systems and methods disclosed herein, however, allow for context-based features in a vehicle.

Driver assist features, such as autonomous driving features, will help reframe the driver as a traveler. Previously the vehicle industry had to focus the in-vehicle experience on keeping the driver on task for safety reasons (from annoying seat belt chimes to warning lights and alerts). Driver assist features will allow the systems and methods disclosed herein to focus on the wellbeing of the driver, as well, allowing the vehicle to be, as AUDI claims, a third living space. ML models such as those disclosed herein may include and/or involve empathetic AI to support what makes a vehicle traveler human, not just to support their focus on driving-such as removing environmental inconveniences of the driving experience and otherwise assisting with the wellbeing of the traveler.

The above-referenced WALL STREET JOURNAL article linked empathetic AI primarily to a dramatic improvement in personalization, stating that the use of this new tech results in “a palpable philosophical shift to make technology map much more closely to each user . . . . Empathetic technology is poised to enable a completely new generation of highly personalized, AI-driven products and services that we haven't even begun to imagine.” Yet personalization may have reached its limits along with the glorified discipline of Human-Centered Design.

When Human-Centered Design first appeared as the new mindset in product design, it radically overhauled an approach stuck in the past and introduced new tools and skill sets to create the right kind of relationship with users at the time. In an influential TED talk, IDEO's Tim Brown described his own part in the diminishing importance of traditional design: “[I was] making things more attractive, making them a bit easier to use, making them more marketable . . . . I was being incremental and not having much of an impact [as a result of] design becoming a tool of consumerism.”

Through the introduction of Human-Centered Design (aka Design Thinking), the discipline regained its importance and impact. It was a radically new approach that spread quickly from tech to all marketable goods as well as health care and education. The term first appeared at the Netherland's DELFT UNIVERSITY OF TECHNOLOGY in the early 1990s, but it was really STANFORD's D.SCHOOL and IDEO that championed the theory, and APPLE that showed its power in practice. At its core, design thinking brought humanity back to product design. It was the victory of the intuitive, crowd-pleasing empath over the emotionless, task-obsessed engineer—in the personification of Steve Jobs. Shortly after he passed away, John Gage, a co-founder of SUN MICROSYSTEMS and friend of Jobs since their HOMEBREW COMPUTER CLUB days, defined Jobs's legacy: “He saw clearly how to take this enormous complexity and make something a human being could use.” This is the core of Human-Centered Design. Jobs always put users above engineering convenience, anticipating their needs and desires before they realized so themselves.

When APPLE launched the IPAD 2, he drove the point home in his keynote: “Technology alone is not enough. It's technology married with liberal arts, married with the humanities, that yields the results that make our hearts sing.” As much as Jobs lived and breathed human-centered design, this mindset was unique amongst his pioneering tech peers. According to THE ECONOMIST, his success partly happened because in an industry dominated by engineers and marketing people who often seem to come from different planets, he had a different and much broader perspective. Jobs had an unusual knack for looking at technology from the outside, as a user, not just from the inside, as an engineer-something he attributed to the experiences of his wayward youth. “A lot of people in our industry haven't had very diverse experiences,” he once said. “So they don't have enough dots to connect, and they end up with very linear solutions.” Bill Gates, he suggested, would be “a broader guy if he had dropped acid once or gone off to an ashram when he was younger.”

The discipline of human-centered design, while industry-transforming at its peak, may have reached its limits. Music streaming may be used as an example to highlight the shortcomings of human-centered design. A key result of the human-centered approach has been personalization. Music streaming benefited greatly from the ability to gear music listening to personal taste and other preferences. But it remains imperfect. A well-kept secret in music streaming is that despite fine-tuned algorithms and data-scientific models, listeners still skip, on average, half the songs chosen for them. This astonishingly high number of skips results from a design process that focuses entirely on the user, but not on the product itself (in this case the song), nor on any external factors. Human-centered design helped establish music streaming as a major industry, yet it could not evolve the category further.

If the Digital Service Providers (DSPs) had taken song structure in consideration as well, playlisting would have improved, likely leading to much lower skip rates. In the industry there is no arrangement to playlists other than theme. By understanding harmony, beat and tempo of each particular song, play listing could become so much more deliberate, intentionally progressing song selection at the right pace and in a compatible key, creating a powerful flow to the overall experience. Yet the biggest oversight of the DSPs results from flawed thinking; a flaw inherent in the concept of personalization: taste and preferences are not static. They are dynamic and variable.

In a landmark study, the Swedish musicologist Carin Öblad discovered that music listening follows a dual-loop process. In other words, the activity is initiated by both external and internal motivations that mediate our music choices. Human-centered design and the personalization of services don't prioritize context, the external motivation referenced by Professor Öblad. Case in point, a person will likely prefer different music when sitting alone on their living room sofa with a beer in their hands after a hard day of work, than while driving their twelve-year old daughter to school in the morning. Yet, the DSP's playlists remain static and linear; they are the same no matter where, when, and with whom the user is listening. The personalization of digital music has, ironically, turned out to be rather impersonal.

Music listening, like many other activities, is context dependent. If a DSP were to be able to place every stream into the context of each particular situation and circumstance, that service would truly develop an intimate connection with the listener. Context is the next evolution. It relates personalization to the overall situation and circumstance. It transforms any experience into something intimate and useful. Human-Center Design alone could not achieve that, because crucial factors affecting usage were not prioritized. Context-based design is an emerging paradigm where usage context is considered as a critical part of driving factors behind people's choices. It still focuses on the human, but places them within the relevant situation.

Bill Gates famously published a white paper on MICROSOFT's home page in 1996 titled “Content is king.” The new media guru Gary Vaynerchuk recently remarked that “if content is king, then context is god.” That is because context has the ability to transform digital content into intuitive, curated media. Personalization caters to personal taste and preferences but can deliver an inadequate experience because taste and preferences are dynamic and variable. Contextualization, on the other hand, relate personalization to the overall situation and circumstance and transform the experience into something truly intimate and useful. The systems and methods disclosed herein are configured for contextualization of this form, not just personalization, because they gather and determine information related to the context of travelers in a vehicle.

Empathetic AI may become the “new normal” in luxury cars. The industry is currently in an arms race to deliver sensor technology and software that can detect nuanced human emotions, complex cognitive states, activities, interactions, and objects people use. TESLA, TOYOTA and FORD are just three of the prominent car makers who appear close to a breakthrough, while Tier 1s like APTIV (through its investment in AFFECTIVA) are investing heavily in the technology. A key reason is that people simply expect it. With the ubiquity of mobile devices and information at their fingertips, people assume the same experience in their cars. They want an in-cabin environment that's adaptive and tuned to their needs in the moment. Yet there are still several challenges to conquer, such as Big Data “analysis paralysis” and mood detection accuracy.

In the age of Big Data, we can easily get overwhelmed with the amount of data we collect. It is a problem experts have termed “Analysis Paralysis.” We can collect all kinds of passenger data in the car and augment it with social media data and marketplace data. The opportunities are endless, and so are the dangers. Flooding a database with non-essential data can overwhelm a system (or its creators) and deem analysis meaningless.

Big Data is defined by the five Vs: volume, velocity, variety, value, and veracity. One software/IT challenge is how to manipulate this vast amount of data that has to be securely delivered, reach its destination intact, and applied in real-time to support the passenger. It boils down to which data is actually valuable; useful for our specific purpose and not needing “clean up.” The idea of hardcore focus is not novel in tech. But, despite decades of success stories in its application, the industry still falsely romanticizes the “more is better” dogma.

With regards to mood detection, emotions are inherently difficult to read. AI is not yet sophisticated enough to understand cultural and racial differences. For instance, a smile may mean one thing in Germany and another in Korea. Furthermore, pinpointing the many nuanced types of emotions without interaction and follow-up probes can be misleading (e.g., disgust). Perceiving the differences between similar emotions is not the only challenging part. People usually experience a range of emotions, all at once or in short order, making the task of mood detection even harder.

However, there has been progress. Multimodality (e.g., combining macro and micro facial expressions, combining biometrics and facial coding) has increased accuracy to nearly 80% and to even over 90% for key emotions. As with any machine learning and Big Data system, our capacity to capture a baseline for each regular passenger will only increase comprehension further.

With regards to facial recognition, it has been the go-to measurement for the Human Perception AI industry. That makes sense for psychotherapy, athletic performance, new work, and media analytics. The face provides a rich canvas of emotion and humans are innately programmed to express and communicate emotion through facial expressions. However, in or on a vehicle (e.g., in a car), facial expression is not a reliable indicator of emotion. The traveler's primary focus lies on the road and operating the vehicle, not on expressing their affective mood. That makes the interpretation of facial expressions, head orientation, and eye movements often misleading. In a car, multimodal analysis must rely on more sensors and measurements than in other environments to overcome the situational limitations of facial recognition.

Challenges to data collection may be overcome by: focusing on a lean data set; going even beyond multi-modal into a holistic data analysis; and simplifying mood analysis.

Empathy is about understanding and supporting the traveler. This may involve pinpointing in-vehicle context with high accuracy. The automotive industry, as much as any other industry, tends to fall into two traps when it comes to Big Data and its applications: capturing as much data as possible; and placing too much focus on monetization and marketplace applicability. In-vehicle empathetic AI is about being a wellbeing resource in the car to ensure a comfortable state of driving (and functioning). In implementations the systems and methods disclosed herein may work accurately and in real-time by only capturing data that is truly useful in the endeavor, and not being seduced into adding unnecessary complexity.

The systems and methods disclosed herein may involve or include empathetic AI and may be configured to shape every kind of car trip that deserves its own experience. Accordingly, one major built-in design constraint or parameter may be as follows: the experience may be determined by the trip and its specific qualities. Based on this philosophy, there may be six major qualities of context that define a trip, as defined above (trip progression, intent, social dynamic, state of mind, trip conditions, and regularity of the trip). By narrowing data collection to these six characteristics, the volume, velocity, variety, value, and veracity of the data may be optimized.

While emotions are inherently difficult to read, as indicated above some progress has been made. Multimodality (e.g., combining macro and micro facial expressions, combining biometrics and facial coding) has increased accuracy to nearly 80% and to even over 90% for key emotions. However, the systems and methods disclosed herein may go beyond multimodality into a holistic trip analysis to truly gain clarity. In order to understand the cause and effect of one's emotions, the systems and methods may consider, analyze and comprehend all six critical characteristics of each drive, as described above. For example: a sudden spike in arousal, coupled with a significant drop in valence is clarified when also considering the on-board's detection of sudden de-acceleration and heavy use of the brakes, coupled with the ambient noise detection of screeching tires, and the acoustics of an expletive uttered by the driver, while shifting in body position.

Referring again to FIG. 17A, in implementations biometric sensors and vehicle sensors are included in the system 100. Biometric sensors and vehicle sensors could include (but are not limited to) the following: pulse sensors; breathing rate sensors; body temperature sensors; oxygen saturation sensors; degree of blood flow sensors; oxytocin level sensors; steering wheel grip and angle sensors; galvanic skin response sensors; electrocardiogram (ECG) sensors; skin conductance sensors; heartrate sensors; blood pressure sensors; perspiration sensors; movement or motion sensors; one or more cameras; one or more microphones; and so forth. Some of these biometric sensors could be built into or incorporated in the vehicle itself (such as pulse testing built into a steering wheel), while some of the biometric sensors could be external but communicatively coupled with the vehicle (such as gathered from a smart watch, a smart ring, a smart bracelet, etc.). Such sensors may measure a traveler's vital signs and may be used by system 100 to infer psychological and physiological arousal, state of flow, and brain activity. The practitioner of ordinary skill in the art will know how to select appropriate biometric sensor types to sense/determine desired biometric information about travelers.

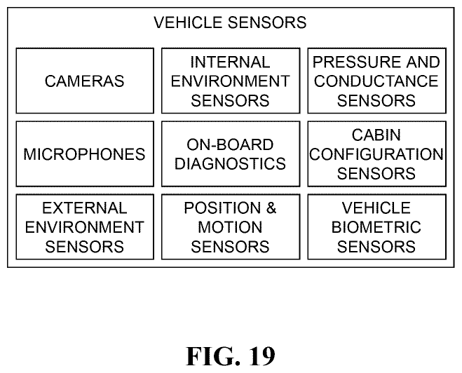

Referring now to FIG. 17A, it is seen that the trip brain 1752 may communicate with one or more vehicle sensors to accomplish certain methods. FIG. 19 shows that the vehicle sensors may include, by non-limiting example, one or more cameras, internal environment sensors, pressure and conductance sensors, microphones, on-board diagnostics, cabin configuration sensors, external environment sensors, position and motion sensors, and vehicle biometric sensors. Each of these sensors and sensor types could be part of the vehicle itself and/or could be simply communicatively coupled with the vehicle if not part of the vehicle itself. In implementations all of the elements of FIG. 17 or 17A (apart from the external computing device) could be part of the vehicle 122 of FIG. 1.

Cameras could include light sensors to determine illumination level, infrared sensors to determine heat or temperature levels, cameras to determine pupil size, and so forth. Pressure sensors could be located in seats, in a steering wheel, and so forth. Conductance sensors could be located on a steering wheel. Pressure and/or conductance sensors in/on the steering wheel could determine or help determine a user's grip pressure and/or position/angle of hands, and so forth. Internal environment sensors could determine cabin temperature, pressure, oxygen level, humidity, olfactory sensors to determine smells, and so forth. External environment sensors could determine external temperature, weather conditions, air pressure, lighting, and so forth. Position and motion sensors could include accelerometers, global positioning satellite (GPS) and other position sensors, gyroscopic sensors to determine pitch/angle of the user and/or vehicle in any three-dimensional (3D) direction, and so forth. Cabin configuration sensors could include sensors to determine position settings of seats, volume settings of audio, lighting settings within the cabin, window positions within the cabin, air conditioning and/or heating settings within the cabin, seat warmer/cooler settings, and other settings within the cabin. The practitioner of ordinary skill in the art will know how to select appropriate sensor types to sense/determine desired information related to the vehicle, its cabin, vehicle settings, and so forth.

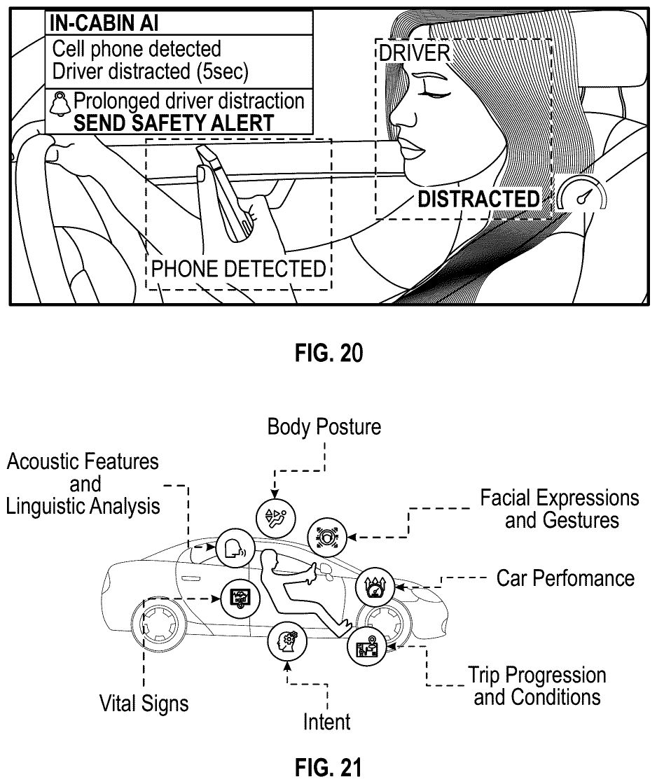

Cameras (of the vehicle and/or of a user's phone or other computing device, communicatively coupled with the vehicle), could measure macro and micro facial expressions. This can include (but is not limited to) the following data types: eye flutter, gaze, smile level, facial muscle activation, head movement, and potential focus on NFC objects (or, in other words, objects communicatively coupled with the vehicle through a near-field communication coupling or another communicative coupling). FIG. 20 representatively illustrates, for example, that in-cabin AI or the aforementioned machine learning model may detect, using a variety of sensor inputs including cameras and NFC sensors and so forth, that a cell phone is present, that the driver has been looking at the cell phone for five seconds and is accordingly distracted, and that a safety alert should be sent to the driver. The driver may then be sent such an alert, by an audio and/or visual notification in the cabin, or on the phone (such as through the use of an associated installed software app on the phone configured to display a notification over the user's current screen/interface), or so forth.

In implementations biometric and vehicle sensor information may be used by the ML model to determine or infer three emotional criteria: alertness, valence, and arousal. They may similarly be used by the ML model to determine level of engagement, level of distractedness, and state of flow. As indicated above, relying solely on facial analysis may not be as useful, but facial analysis may be a useful component of a holistic analysis. Detection of a smile, a furrowed brow, tightened eyelids, a raised chin, a sucked lip, an inner brow raise, a lip corner depression, a lip stretch, and so forth, may be indicators of specific emotions. The system may, using the ML model and/or administrator input, map facial expressions to various emotions.

As indicated above, vehicle sensors may include pressure sensors. In implementations, seat pressure sensors may measure body posture and/or may provide the following data types: body activity and direction leaning (i.e., a direction in which the traveler is leaning). Such information may be used by the system and/or ML model to determine or infer driver engagement, arousal and alertness. Microphones may be used to measure acoustic features, ambient noises, and to allow the system and/or ML model to conduct linguistic analysis. Microphones may provide or facilitate the following data types: vocal parameters and fluency, and tone and sentiment extraction. The system and/or ML model may use this data to determine or infer valence, arousal, alertness, state of flow, the social dynamic in the car, and strength of social connection(s) amongst the passengers.

Vehicle sensors may include on-board diagnostics which measure or determine the car's or vehicle's performance. This may include (but is not limited to) the following data types: vehicle speed (and the delta vs. the speed limit), acceleration, cabin temperature, and so forth. Such data may be used by the system and/or ML model to determine or infer the effect or correlation of such vehicle factors to the traveler's alertness, arousal, and so forth.

Vehicle sensors may gather data related to GPS position, weather, trip progression, and trip conditions. They may provide the following data types: evolution of trip, duration, types of roads, toll markers and other notable markers, traffic conditions, weather, time of day, traveler familiarity with route, and so forth. The system and/or ML model may use such data to determine or infer the effect of such factors on traveler alertness and arousal.

In implementations, a combination of GPS (start and end points) data, calendar entry, time of day, pattern, and social dynamic in the car may be used by the system and/or ML model to determine or suggest an intent of a trip (in other words, the trip's purpose, such as a commute, errand, road trip, trip to a meeting, and so forth).

FIG. 21 representatively illustrates data that may be gathered by various sensors (vehicle sensors and/or biometric sensors) and analysis that the system and/or ML model may perform based on such data, including determining body posture, facial expressions and gestures, car performance, trip progression and conditions, traveler vital signs (biometric information), acoustic features, and so forth. The system and/or ML model may perform linguistic analysis and may otherwise analyze the sensed information/data to determine a trip intent and to provide a variety of other services/features, such as tailoring audio/music and/or interactive conversation agent features to the determined emotional or mental state of the traveler(s). FIG. 21 only shows some representative examples of gathered data and/or system/model determinations, and is not exhaustive.

Table 1A below gives additional details on data that may be gathered by sensors and/or analyzed by the system and/or ML model to make determinations as to mental state, alertness, valence, arousal, and so forth. This table is an example taken from the following publication which is incorporated herein by reference: “Technical Design Space Analysis for Unobtrusive Driver Emotion Assessment Using Multi-Domain Context,” David Bethge et al., Proc. ACM Interact. Mob. Wearable Ubiquitous Technol., Vol. 6, No. 4, Article 159, published December 2022. Systems and methods disclosed herein may use or include any other details or characteristics disclosed in this reference.

TABLE 1A
Data Collection Details

| Context | Feature | Details |
|---|---|---|
| Reference Data | frame_number | The number reference for the session snapshot |
| | timestamp | frame pair, e.g., 21/10/15, 18:55:39:0025. |
| | audio_file_path | p_01/session_id/audio.mp4 |
| | front_frame_path | p_01/session_id/imgs/front_frame_501.jpg |
| | back_frame_path | p_01/session_id/imgs/back_frame_501.jpg |
| Personal | sex | male, female, other |
| | car_model | e.g., VW Polo, Porsche Taycan |
| | age | Participant's age. |
| | participant_id | e.g., p_01, p_02 |
| | emotion_before | Emotion before ride. |
| Session | session_id | e.g., 0751B8E9-3357-47E3-A862-CBFC60B88555 |
| | session_start | e.g. 21/10/15, 18:54:49:0015 |
| | session_end | e.g. 21/10/15, 19:14:69:0485 |
| Session Time | weekday | Mon. Tue. Wed. Thurs. Fri. Sat. Sun. |
| | daytime | Morning, Afternoon, Evening, Night |
| Motion | acceleration_x | Acceleration on the x axis. |
| | acceleration_y | Acceleration on the y axis. |
| | acceleration_z | Acceleration on the z axis. |
| | vemotion_acceleration | (or acceleration_v1) Acceleration as in VEmotion. |
| GPS | speed | Vehicle speed in km/h. |
| | latitude | Latitude value of current location. |
| | longitude | Longitude value of current location. |
| Traffic Data | current_travel_time | Current travel time in seconds. |
| | free_flow_speed | Free flow speed expected under ideal conditions. |
| | current_speed | Current average speed at the selected point. |
| | free_flow_travel_time | Travel time (secs) under ideal free flow conditions |
| | reduced_speed | Calculated by free_flow_speed minus current_speed |
| Weather Data | wind_speed | Outside wind speed in km/h. |
| | precipitation_24h_mm | Rain fall measurement in millimeters. |
| | feel_temp_outside | “Feels like” temperature in Celsius. |
| | cloud_cover | Percent representing cloud cover. |
| | weather_term | e.g., cloudy, mostly cloudy, mostly sunny, sunny |
| Road Data | road_type | e.g., cycleway, footway, living_street, residential. |
| | max_speed | Max allowed speed for current road. |
| | num_lanes | Count of available lanes on the road. |
| Facial Expression | facial_expresssion_label | Front-facing camera's classified emotion. |
| Prediction | | |
| Perceived Emotion | label | Emotion expressed by party during experiment. |
| Audio | audio_amplitude | Audio amplitude avg for duration of chunk. |
| | audio_loudness | Audio recording avg loudness for duration of chunk. |
| | audio_zero_crossings | Audio zero crossing rate of correspondent chunk. |
| Visual Complexity | num_cars, num_people, | Num. of objects detected in the back-facing camera |
| (Object Detection) | bicycles, pedestrians, | frame per class. |
| | motorcycles, buses, trucks, | Num. of objects at estimated distances from |
| | traffic_lights, traffic_signs | camera. |
| | num_med_close_objs, | |
| | num_very_close_objs, | |
| | num_close_objs, | |
| | num_very_far_objs, | |
| | num_far_objs | |
| Visual Complexity | road, sidewalk, building, | Percentage pixels in back-facing frame representing |
| (Segmentation) | wall, fence, pole, traffic | class. |
| | light, traffic sign, | |
| | vegetation, terrain, sky, | |
| | person, rider, car, truck, | |
| | bus, train, motorcycle, | |
| | bicycle | |

A combination of human, circumstantial, and environmental data can determine the context of a trip, and may be used by an ML model or empathetic AI to provide contextual interventions for wellbeing and safety. As examples, and referring again to FIG. 21, Table 1B gives, for a plurality of data categories: data sources, data types, and inferences made by the system based on the gathered data. Any of the data sources may themselves be components of the system of FIG. 1.

TABLE 1B
Example Data Categories, Sources, Types, and Inferences

| Data Category | Data Source | Data Type | Inferences |
|---|---|---|---|
| Acoustic Features | microphone | vocal parameters, | alertness, valence, |
| and Linguistic | | fluency, tone and | arousal, state of |
| Analysis | | sentiment | flow, social dynamic |
| | | extraction | in vehicle, strength |
| | | | of social connection |
| | | | among passengers |
| Body Posture | Seat and steering | body activity, | engagement, |
| | wheel pressure | direction of leaning, | arousal, alertness |
| | sensor | grip | |
| Facial Expressions | camera | macro and micro | alertness, valence, |
| and Gestures | | expressions, eye | arousal, level of |
| | | flutter, gaze, smile | engagement or |
| | | level, facial muscle | distractedness, |
| | | activation, head | expressiveness, |
| | | movement, focus | state of flow |
| | | on NFC object | |
| Car Performance | on-board | destination, speed | situational effect on |
| | diagnostics | (vs. speed limit), | driver alertness and |
| | | acceleration, | arousal |
| | | temperature | |
| Vital Signs | biometric sensors, | pulse, breathing | psychological and |
| | ECG skin | rate, body | physiological |
| | conductance sensor | temperature, | arousal, state of |
| | | oxygen saturation, | flow, brain activity |
| | | degree of blood | |
| | | flow, oxytocin | |
| | | levels, steering | |
| | | wheel grip and | |
| | | angle, galvanic skin | |
| | | response | |
| Intent | GPS (start and end | determination of | situational effect on |
| | points), calendar | purpose (e.g., | driver alertness and |
| | entry, time of day, | commute, errand, | arousal |
| | pattern, social | road trip, trip to a | |
| | dynamic | meeting) | |
| Trip Progression | GPS, weather, | evolution of trip | situational effect on |
| and Conditions | microphone | (duration, types of | driver alertness and |
| | | roads, notable | arousal |
| | | markers such as toll | |
| | | markers), traffic | |
| | | conditions, | |
| | | weather, time of | |
| | | day, familiarity with | |
| | | route, ambient | |
| | | noise | |

Various genres of driving may be classified. To some extent there is no such thing as a standard trip. Each trip in the car is unique, characterized by unique qualities. A drive alone to work creates a completely different dynamic in the cabin than a drop-off of the driver's daughter at her middle school. These may entail different speeds, mindsets, in-vehicle atmosphere, and so forth. The system and/or ML model may accordingly select very different music to incorporate into a playlist and/or to otherwise play using the infotainment system. Even if the driver is alone in the car (which is the predominant traveler situation today), there are still major differences that go beyond in-vehicle social dynamics (e.g., alone vs. with daughter) and intent (e.g., commute vs. drop-off). Every trip deserves its own bespoke experience, and that experience is determined by system and/or ML model after determining/identifying the type of trip and its specific qualities.

With regards to classifying the trip type, such classification may in implementations involve grouping objects together based on defined similarities such as subject, format, style, or purpose. Genre classification as a means of managing information is already well established in music (e.g., folk, blues, jazz), but also is used in retail settings, for instance in book stores where there is a children's section, a fiction section, a business section etc. In automotive/vehicle settings, the characterization of information using “genre” is not a well-defined notion.

In implementations, classifying the type of drive may facilitate the system and/or ML model intuitively automating audio content and physical conditions in the car. This may allow for an empathetic AI system within the vehicle. As indicated above, every trip may deserve its own bespoke experience, and that experience may in implementations be determined by the system and/or ML model using the type of trip and its specific qualities.

Different states of driving may be classified. One benefit of in-vehicle empathetic AI is the improved wellbeing of the travelers. As indicated above, wellbeing as it relates to driving involves a traveler's state of functioning. In-vehicle empathetic AI may be facilitated by determining various states of driving. In implementations driving states may be categorized into four types, each of which may be a subset of comfortable driving. The specific driving state may in implementations depend on the situation, the internal and external environment, and in-vehicle dynamics. The four types in implementations are observant driving, routine driving, effortless driving, and transitional driving.

The state of observant driving is defined by the extra caution the driver is expected to attend to, such as when challenging road and traffic conditions (e.g., heavy traffic), bad weather, and/or an unfamiliar locale require intense focus on navigation. Examples are a traffic jam or rush hour drive. Observant driving requires extra focus on navigation and traffic conditions. Observant driving can in implementations be defined as driving in which one or more of the following are detected or determined to be present or to be upcoming: a traffic slowdown of a predetermined threshold below a speed limit; a calculated traffic jam factor beyond a predetermined threshold; rain; snow; fog; wind speed above a predetermined threshold; temperature beyond a predetermined threshold (for example below a preset low temperature or above a preset high temperature); driving between a predetermined time range; driving during a predetermined rush hour time range; driving a threshold amount beyond a speed limit (such as 10 MPH above a speed limit or 10 MPH below a speed limit); a structural obstruction; a toll location; light conditions beyond a predetermined threshold (for example luminosity or illumination below a predetermined amount or level or luminosity, or illumination above a predetermined amount or level in the driver's field of view such as the sun in the driver's eyes); a driving location the driver has not previously traversed; and a driving location the driver has traversed below a predetermined amount of times. These are only non-limiting examples and this list is not comprehensive.

The state of routine driving is defined by the mundaneness of the drive such as when familiar, often shorter, trips let the driver think of the tasks ahead or focus on the in-cabin music. Examples are routine errands, commutes to work, and drop-offs. Such driving lets the traveler/driver focus on things besides safe driving. Routine driving can in implementations be defined as driving in which one or more of the following are detected or determined to be present or to be upcoming: a total estimated travel time below a predetermined time limit; a driving location the driver has previously traversed; a driving location the driver has previously traversed a threshold number of times; a total trip mileage below a predetermined threshold; mileage of a portion of the trip below a predetermined threshold (for example a freeway portion of the trip being below five miles); travel time of a portion of the trip below a predetermined threshold (for example a freeway portion of the trip being below ten minutes); a commute to work; absence of rain; absence of snow; absence of fog; wind speed below a predetermined threshold; light conditions beyond a predetermined threshold (for example above a predetermined luminosity or illumination amount, or light above a predetermined luminosity or illumination amount not being in the driver's field of view); and a drop off of a passenger. These are only non-limiting examples and this list is not comprehensive.

The state of effortless driving is defined by the way the driver may be mindful. Examples are commutes, empty highways, and road trips. Such trips are uncomplicated, often routine, trips, with favorable road and traffic conditions that let one think about the tasks ahead or reboot one's brain. Effortless driving can in implementations be defined as driving in which one or more of the following are detected or determined to be present or to be upcoming: a commute having an expected mileage above a predetermined threshold; a commute having an expected travel time above a predetermined threshold; traveling on a highway; traveling on a freeway; traveling on an interstate; a total expected travel time beyond a predetermined amount of time; expected travel time for a trip portion (for example travel time only on a freeway or interstate portion of a trip) beyond a predetermined amount of time; a driving location the driver has previously traversed; a driving location the driver has previously traversed a threshold number of times; a vacation-related trip (for example starting or ending a vacation as determined by calendar events or by other mechanisms); an absence of a traffic slowdown of a predetermined threshold below a speed limit; a calculated traffic jam factor within a predetermined threshold; an absence of structural obstructions; a lack of toll locations; absence of rain; absence of snow; absence of fog; temperature above a predetermined threshold; temperature within a predetermined range; temperature below a predetermined threshold; wind speed below a predetermined threshold; light conditions beyond a predetermined threshold (for example luminosity or illumination above a certain threshold but without sun or the like in the driver's eyes or field of view); driving within a predetermined time range; a consistent or constant speed limit for a predetermined amount of time or mileage; and driving outside of a predetermined rush hour time range. These are only non-limiting examples and this list is not comprehensive.

The state of transitional driving is defined as “let-your-guard-down” trips. Examples are the commute home from work, drives to dinner, or drives to hobby-related activities (e.g., athletic practice, the art studio, etc.). These trips let the traveler transition from one persona to another (for instance from boss at work to wife and mom, from engineer to soccer team-mate, etc.) and let their guard down.

Transitional driving can in implementations be defined as driving in which one or more of the following are detected or determined to be present or to be upcoming: a commute home; an estimated amount of time or mileage, to a determined end location from a present location, below a predetermined threshold (for example within five miles or within fifteen minutes of home, or a yoga studio, or a grocery store); and a determination of a different activity type at the end location relative to an activity type at a starting location (for example using calendar entries or machine learning based on past behavior to determine that the driver is leaving work to go to the gym (a transition from work to exercise), or leaving the gym to go to a restaurant (a transition from exercise to eating), or leaving home to go to work (a transition from relaxing to working), or leaving work to take a lunch break (or returning from a lunch break to work), and so forth. These are only non-limiting examples and this list is not comprehensive.

Each of these different states of driving may involve different functioning, and different methods/mechanisms may be used by the system and/or ML model to improve or help the traveler's wellbeing. A desired mental state during observant driving may be cautious, with heightened perception, but not apprehensive. The focus in such situations may be extra safety. In order to achieve that the driver may need to stay calm rather than becoming apprehensive (which could result in overreaction).

A desired mental state during routine driving may be the traveler being at ease, with alert consciousness. In these situations the driver knows what they are doing. While they must remain alert to traffic conditions, they can do so with less poise.

A desired mental state during effortless driving may be the traveler being serene (physically and mentally relaxed). In driving situations that require less focus, the driver can let their subconscious go to work.

A desired mental state of transitional driving may be the traveler being forward looking (excited consciousness). In these driving situations, the focus may lie on preparing the traveler/driver for their next role—to use the drive as a liminal phase from one persona to the next, and prepare for and anticipate what comes next.

As discussed, an ML model of the system may include or comprise empathetic AI to improve a traveler's driving/passenger experience and overall wellbeing. Such an ML model may be configured to encourage or elicit optimal brainwaves and emotions of targets (drivers and passengers) during travel and/or for overall wellbeing. The driving classifications discussed above may determine or affect the ML model configuration. Each of the four defined core states of driving may benefit from a distinctive state mind in the driver/passenger(s), and the ML model and system may encourage, elicit, or support by altering/controlling physical conditions in the vehicle and/or altering/controlling specific applications within or configurations of the infotainment system.

For each of the above-defined states of comfortable driving, the system and/or ML model may have a predetermined corresponding brainwave and/or emotional state target. For brainwaves, the system and/or ML model may have target frequency ranges for the different driving states.

For example, during observant driving the brainwave target may be in the lower Gamma range, such as 32-50 Hz. In that range it is expected that a driver would have heightened perception and heightened cognitive processing to help them drive safer in difficult traffic. During routine driving, the brainwave target may be in the lower Beta range, such as 13-20 Hz. In that range it is expected that the driver will achieve alert consciousness, which may help put them at ease. During effortless driving the brainwave target may be in the lower Alpha range, such as 8-11 Hz. In that range it is expected that the driver will become physically and mentally relaxed, which will help their minds wander and mentally recharge. During transitional driving, the brainwave target may be in the upper Beta range, such as 20-30 Hz. In that range it is expected that the driver will achieve excited consciousness, which helps them look forward to their next role.

Although the above examples discuss target brainwave ranges for drivers, in implementations the system and/or ML model may focus on affecting the brainwaves of passengers as well or alternatively. In some cases the system and/or ML model may prioritize the brainwave ranges of drivers, to ensure safe driving, but the system and/or ML model may also attempt to affect brainwaves of passengers independently. This could involve, for example, adjusting the seat temperature and/or AC/heating and/or lighting in a passenger area differently than in the driver area, to accomplish different brainwave targets for a passenger versus a driver, based on a determined approach more likely to improve wellbeing for a specific passenger or set of passengers versus a driver. In some cases the system and/or ML model could prioritize the wellbeing of a passenger. For example if the system determines that a specific passenger is upset, while the driver is determined by the system to not be upset (or not be as upset), the system may prioritize affecting the brainwave range and/or emotions of the passenger, to attempt to calm down the upset passenger and achieve a more peaceful or positive atmosphere in the vehicle. The system may react differently when determining that vehicle occupants are arguing, or that one or more vehicle occupants is crying or otherwise showing strong emotions, to support overall wellbeing for drivers and passengers.

In some cases the system may actually measure brainwave activity with sensors to receive feedback and/or to determine if the brainwave targets are being achieved. For example, the system may include a hat or unobtrusive headpiece to be worn during driving, the hat or headpiece including brainwave sensors for input/feedback to the system and ML model to help the system and ML model to more easily reach the target brainwave frequency range. In some cases, however, the system may exclude such sensors and may attempt steps which are likely to achieve the desired brainwave frequency ranges, but without actually knowing whether the brainwave frequency ranges are received. The system may determine, however, based on circumstantial evidence from other sensory inputs (such as tone of voice, sitting position, eye movement, heart rate, etc.), whether the brainwave frequency has likely been reached, by using known or determined correlations between brainwave frequency ranges and such physical details.

The system and/or ML model may have certain emotion targets for drivers and/or passengers. In some cases precise emotion detection may not be needed in order to satisfactorily achieve traveler wellbeing, as will be detailed below. However, precise emotion detection may be undertaken in some circumstances.

For background, it is pointed out that in psychology “valence” is an affective quality referring to the intrinsic attractiveness/“good”-ness or averseness/“bad”-ness of an event, object, or situation. Emotions popularly referred to as “negative,” such as anger and fear, have negative valence. Joy has positive valence. Valence measures the nature of a person's experience; whether a person is in a pleasant (e.g., happy, pleased, hopeful) or unpleasant (e.g., annoyed, fearful, despairing) state.

In psychology “arousal” is a physiological and psychological state of being awake. It involves the activation of the reticular activating system in the brain stem, the autonomic nervous system and the endocrine system, leading to increased heart rate and blood pressure and a condition of sensory alertness, mobility and readiness to respond. During an actual awake state a person can have varying levels of arousal. Arousal measures how calm or soothed versus excited or agitated a person is.

In psychology, alertness is the state of paying close and continuous attention. It is the opposite of inattention, which is failure to pay close attention to details or making careless mistakes when doing work or other activities, trouble keeping attention focused during tasks, appearing not to listen when spoken to, failure to follow instructions or finish tasks, avoiding tasks that require a high amount of mental effort and organization, excessive distractibility, forgetfulness, frequent emotional outbursts, being easily frustrated and distracted, and so forth. Alertness measures the state of active attention and awareness; how watchful and prompt a person is to meet danger, or how quick they are to perceive and act.

As used herein, the terms valence, arousal, and alertness have the meanings and/or definitions given above. For the purposes of this disclosure, it is pointed out that emotions with similar valence, arousal and alertness produce analogous influence on state of mind, choice and judgment.

In implementations, in order to affect and/or control in-vehicle experiences and wellbeing, the system and/or ML model only needs to adjust or scale these three affective qualities of valence, arousal, and alertness. For example, for the purpose of supporting a traveler functionally and/or emotionally, in implementations the AI does not differentiate between, let's say, anger and fear. Thus, in such implementations the system does not do emotional determination rising to the level of a psychotherapy session, but instead the infotainment system may be used to help make the traveler more comfortable and support their functioning by simply detecting a high arousal state (which may be anger or fear or any other high arousal state) and helping to counteract that. This method of simplifying mood analysis may, in implementations, increase the system's accuracy and effectiveness for its specific purposes. For example, the system may be able to detect and counter high arousal states more accurately and quickly than determining which high arousal emotion is occurring and countering that specific emotion. This is just one example, and there may be other (or different) reasons why simplifying mood analysis increases the system's accuracy and effectiveness. However, in implementations the system may be configured to differentiate between emotions at a more granular level, such as discerning between fear and anger, and having different approaches to such emotions.

In implementations the three affective qualities of valence, arousal, and alertness can be accurately detected/determined by a combination of biometrics, acoustic features and linguistic analysis, facial expressions and gestures, and body posture. In implementations the system may have minimal or no reliance on facial recognition because of the ability to use other inputs/data to determine valence, arousal and alertness.

Referring to Table 2 below, during observant driving, we want the driver to be cautious, but not apprehensive. In implementations the system and/or ML model may prioritize high alertness in this state, followed by neutral to slightly positive arousal, so that the emotional state of the driver is not too hyped and overreactive. In implementations valence in this state may be deprioritized as the least important quality, and may be neutral.

TABLE 2
Targets During Observant Driving

| | |
|---|---|
| Valence | 0 |
| Arousal | 0 |
| Alertness | +++ |

Referring to Table 3 below, during routine driving the system may attempt to put/keep the driver at ease. In such instances the system may prioritize positive valence, with neutral arousal, and a positive level of alertness, to ensure a safe drive.

TABLE 3
Targets During Routine Driving

| Valence | ++ |
|---|---|
| Arousal | 0 |
| Alertness | 0 |

Referring to Table 4 below, during effortless driving the system may attempt to keep/put the driver in a serene, relaxed state to let their mind wander. Stable emotions may help with this. The system may therefore attempt positive valence, coupled with neutral arousal and alertness.

TABLE 4
Targets During Effortless Driving

| Valence | + |
|---|---|
| Arousal | 0 |
| Alertness | 0 |

Referring to Table 5 below, during transitional driving the system may attempt to get/keep the driver excitedly looking forward to what comes next. The system may do this by focusing on highly positive valence, positive arousal, and neutral alertness.

TABLE 5
Targets During Transitional Driving

| Valence | +++ |
|---|---|
| Arousal | + |
| Alertness | 0 |

The above valence, arousal, and alertness targets are useful examples, but in implementations the system and/or ML model may have different targets for some of the above driving states. Table 6 below summarizes some example brainwave targets, emotion targets, and expected or hoped-for effects for the different states of driving.

TABLE 5
Summary of Example Targets and Effects for Driving States

| State of | Brainwave | Emotion Target | | | |
|---|---|---|---|---|---|
| Driving | Target | Valence | Arousal | Alertness | Effect |
| Ob- | Heightened | 0 | 0 | +++ | Cautious (not |
| servant | Perception | | | | apprehensive) |
| Routine | Alert | ++ | 0 | + | At ease |
| | Consciousness | | | | |
| Effort- | Physically & | + | 0 | 0 | Serene |
| less | Mentally | | | | |
| | Relaxed | | | | |
| Tran- | Excited | +++ | + | 0 | Forward |
| sitional | Consciousness | | | | looking |

Once the context is determined, and the targets set or determined, the in-cabin systems and features can be utilized by the system 100 and/or ML model to either help reinforce the traveler's state of mind or intervene and correct it, as desired. For example, four types of applications/conditions which may influence a traveler's comfortable state of driving are: (1) drive assist applications; (2) applications/features related to physical conditions in the cabin; (3) infotainment content; and (4) details, features and/or configuration of a conversation agent.

With regards to drive assist applications, the vehicle industry has introduced self-parking, lane change warnings, rear cameras, etc., that reduce the stress of actual driving and make the driver more comfortable. Some such applications can be beneficial and/or should be used regardless of state of driving. Accordingly, in some instances the system and/or ML model may not adjust or affect drive assist applications. For example, whether a driver needs to be extra alert due to bad traffic or road conditions, or whether a driver can recharge their brain during a stretch of light steady traffic, safety should remain a priority. Even so, in some cases the system and/or ML model may affect or interact with drive assist features to affect brainwave and emotion targets—for example recommending that a user turn certain safety features on, or notifying the user when they have been turned off, or defaulting to automatically turning some safety features on, and so forth.

With regards to physical conditions, the in-cabin environment (such as in-cabin temperature, lighting, and noise) can have a great impact on a person's driving ability, creative thinking, and mood regulation. The Italian Association of Chemical Engineering published a landmark study in 2017 on the characteristics on Indoor Environment Quality (IEQ). The study divided the most important characteristics of IEQ into two parameters, one relating to energy that normally affects human physiology, and one influencing human psychology. The systems and methods disclosed herein may use both to affect comfortable driving, by using the disclosed reinforcements and interventions.

Another project called the “Hawthorne Studies,” run by the Harvard Business School for over 15 years, observed and interviewed more than 20,000 workers and defined what is called the Hawthorne effect: regardless of the nature of experimental manipulation employed by the researchers, work performance always increased. No matter what the researchers did, whether they increased or decreased lighting or temperature or humidity, productivity always appeared to improve. The explanation for these findings was that workers were responding to the attention that researchers paid to them, rather than changes to physical conditions in the workplace. In line with this, the systems and methods disclosed herein may alter physical conditions in a vehicle and pay attention to travelers' needs. Such findings may also be used to modify cabin designs.

Subsequent studies have indicated that they determined both the physiological and psychological effects of in-cabin physical conditions, and under which circumstances the optimal setting varies. Studies in both the automotive and office-work related fields suggest that there are six qualities in an environment's physical conditions that can help people move towards the respective ideal state: illumination (light and color); temperature; body position; acoustic control; humidity; and air quality.

With regards to illumination, the optimal illumination varies depending on the particular state of driving. The same light may be too dim or too bright, or have the wrong color, depending on the traveler's state of mind, gender, age, and/or other factors. The Industrial Ergonomists Henri Juslén and Ariadne Tenner indicated that beyond safety and visual comfort, the right lighting may also influence cognitive performance and problem-solving ability by interfering with circadian rhythms. The lighting and visibility expert Dr. Peter Boyce found that lighting can impact mood and interpersonal dynamics.

Another interesting aspect of lighting is its color. Multiple studies have confirmed that the ideal color depends on both age and gender. For instance, in a study conducted by University of Gävle's Igor Knez and Christina Kers, older adults showed a negative mood in cool bluish lighting, while younger adults (in their mid-20's) showed a more negative mood in warm, reddish light. Eindhoven University of Technology's Peter Mills and Susannah Tomkins found that fluorescent light sources with high correlated color temperature (17,000K) improved concentration, fatigue, alertness, performance, and mental health. Especially blue-enriched white light (17,000K) improved reduced daytime sleepiness and alertness.

It is useful to control lighting during early morning and nighttime driving to help the user stay awake and alert. Light mediates and controls a large number of biochemical processes in the human body, such as control of the biological clock and regulation of some hormones (such as cortisol and melatonin) through regular light and dark rhythms. It may be worthwhile experimenting on the possible effects or distraction of repeated brief exposures to bright light during dark drives.

During observant driving, brighter lighting (at about 1,200 lux) may be used to improve productivity and alertness. For routine driving there may be no special or desired lighting setting. During effortless driving, dimmer lighting (at about 800 lux) may be used to improve creative thinking. During transitional driving, lighting color may be selected to improve traveler mood, the selected/right color depending on traveler gender and age.

With regards to cabin temperature, the optimal cabin temperature can vary depending on the particular state of driving. Temperature can have a huge effect on human psychology and physical condition. The ergonomist Neville Stanton studied how temperature can affect workers' behavior and productivity. His studies of temperature and productivity found that temperature between 21-22° C. (70-72° F. will increase productivity, and as the temperature goes up between 23-24° C. (73-79° F.) productivity starts to relatively decrease.

The range of 21-23° C. (70-73° F.) is usually referred to as the ideal “room temperature.” However, when it comes to menial alert tasks (like driving through heavy traffic), warmer temperatures may increase focus and attention. A month-long office temperature study conducted by researchers at Cornell University at a major Florida insurance company, for instance, discovered fewer typing errors and higher productivity rates in employees working at 25° C. (77° F.). At this warm temperature, the researchers observed employees typing 100 percent of the time with a 10 percent error rate. Workers typed about 54 percent of the time with an error rate of 25 percent when the temperature was set to 20° C. (68° F.). One issue with cold temperatures is that they can be distracting, and if people are feeling cold they may use more energy to keep warm with less energy going towards concentration, inspiration and focus.

In some cases a warmer environment doesn't just make people more productive but also makes them genuinely happier. In a follow-up study, people were asked to rate the efficacy of heating pads or ice packs and then answer questions about their employer or a hypothetical company. Those who got their hands warm expressed higher job satisfaction and greater willingness to buy from and work at the made-up companies. The study hypothesized that the brain has difficulty differentiating physical sensations from psychological ones. This is interesting considering Yale Psychology professor John Bargh's research of the brain after cold and warm encounters: “The warmed subjects were also more likely than the cold ones to offer to a friend the prizes they received for participation, suggesting a possible overlap between the neural centers of trust and physical comfort.”

To some extent the brain doesn't seem to see a difference between physical warmth and psychological warmth. Warmer temperatures can improve one's mood, activate feelings of trust and empathy, and make people feel more welcoming. Bargh indicated that people who take long, hot showers or baths may do so to ward off feelings of loneliness or social isolation, hypothesizing that we can substitute social warmth, that we might be lacking on any given day, with physical warmth—the brain seeing little difference between the two. Such findings or hypotheses may be used to provide some inputs or default settings to the ML model and/or system, for example with regards to drives that involve role transitions and commutes home when the driver prepares to return to their family after a long stressful day at the office.

The issue of temperature becomes really interesting as the brain switches from simple focus to complex thinking, which often happens during the state of driving academics call “automaticity,” when the mind wanders and works on complex problems subconsciously. This may happen during effortless driving. During such effortless driving the system and/or ML model may control temperature in a way to support such mind wandering.

Ambient temperature can do more than influence productivity, but can also change the way people think. A study by University of Virginia's Amar Cheema and Vanessa Patrick showed that when students had to solve more complex problems that required abstract and creative thinking, they were able to do so twice as effectively in cool temperatures (19° C. or 66° F.) than in warm temperatures (25° C. or 77° F.).

Gender can come into play with regard to temperature as well. In temperature academia there is a rating called the Predicted Percentage of Dissatisfied (PPD). To calculate the PPD, most building managers use a standard 1960s formula, which takes into account factors such as the clothing and metabolic rate (how fast we generate heat) of a building's inhabitants. Tellingly, the latter requires a number of assumptions about their age, weight and, crucially, gender. The metabolic rate which currently controls the office thermostat is based on a 40-year-old, 70 kg man. Boris Kingma from Maastricht University Medical Center decided to take a closer look and found that women have significantly lower metabolic rates than men and need their offices 3° C. (5.4° F.) warmer. The discrepancy is explained in large part by the fact that women have fewer muscle cells and more fat cells, which are less active and produce less heat.

The systems and methods disclosed herein may use embedded technology already available in today's vehicles, or custom technology, to identify gender and adjust temperature, using higher temperatures when a woman is driving.

During observant driving, warmer temperatures (at or about 25° C./77° F.) may be used to improve productivity and alertness. During routine driving, the “ideal room temperature” (at or about 21-23° C./70-73° F.) may be used to keep the traveler at ease. During effortless driving, cooler temperatures (at or about 19° C./66° F.) may be used to improve creative thinking. During transitional driving, warmer temperatures (at or about 25° C./77° F.) may be used to improve mood and help the traveler feel welcomed.

A traveler's body position can be related to their physical condition. The automotive industry has done some development in the area of body position in an attempt to optimize posture in the traveler's seat to improve blood circulation. This feature is not dependent on the type of drive, but may be useful during any type of trip.

With regards to acoustic control, extra noise can reduce focus and the ability to think creatively. It can also increase stress. Several vehicle manufacturers, most notably AUDI, have developed ambient noise controls that can mask the noise coming from outside the car. In certain driving situations that can be beneficial, like in effortless and transitional driving, where the focus lies beyond safety in subconscious thinking and mood regulation. However, in driving situations where safety is still the overwhelming priority, outside noises are necessary to help the driver orient themselves and understand the overall traffic conditions. The systems and methods disclosed herein may accordingly adjust noise cancelation features and/or audio level differently depending on the type of trip or driving type.

While good air quality and optimal humidity (between or about 40-60% relative humidity) are useful aspects of maintaining wellbeing in a vehicle, in implementations they may be maintained at constant levels rather than adapted to specific driving situations. In a study conducted by the University of Alberta's Psychology department, researchers found that out of eight weather variables (hours of sunshine, precipitation, temperature, wind direction, humidity, change in barometric pressure, and absolute barometric pressure), humidity was the best predictor of mood outcomes. On days when humidity was high, participants reported being less able to concentrate and feeling sleepier. They also found a link between high humidity and increased tiredness using controlled experimental methods. In contrast, participants reported increased pleasantness when in low humidity conditions. The systems and methods disclosed herein may adjust humidity to low levels to increase traveler mood, decrease sleepiness, and so forth.

The systems and methods disclosed herein may involve using scent as a possible intervention as well. Some research along these lines has shown potential (e.g., smelling peppermint may in implementations make a person more alert). However, in some implementations fragrance may have less of an impact on travelers than other physical conditions, so fragrance modification may be omitted in some systems and methods.

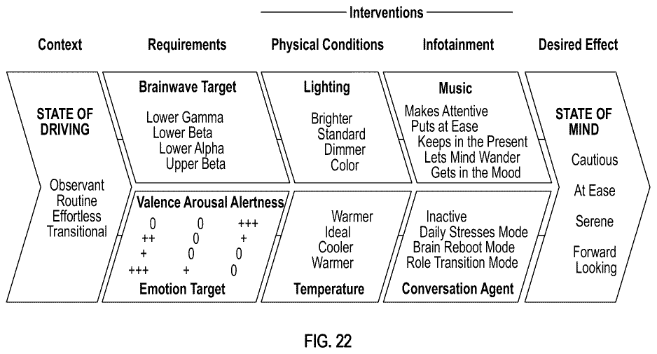

The various contexts or states of driving and related elements are representatively illustrated in FIG. 22. The contexts or states of driving may include: observant, routine, effortless, and transitional. Requirements for each context/state may include brainwave targets and emotion targets. For example the brainwave target for observant driving may be lower gamma, the brainwave target for routine driving may be lower beta, the brainwave target for effortless driving may be lower alpha, and the brainwave target for transitional driving may be upper beta. Similarly, the emotion targets for observant, routine, effortless, and transitional driving, respectively, may be: valence 0, arousal 0, alertness +++; valence ++, arousal 0, alertness +; valence +, arousal 0, alertness 0; valence +++, arousal +, alertness 0. The Interventions include interventions related to physical conditions and infotainment. With regards to physical conditions, each of the four states of driving has a target lighting condition (brighter for observant, standard for routine, dimmer for effortless, and color for transitional). Each of the four states of driving has a target temperature (warmer for observant, ideal for routine, cooler for effortless, and warmer for transitional).

For the infotainment the music for the observant state of driving is selected to make the user attentive, while the music for the routine state of driving is selected to put the user at ease and keep them in the present. For effortless driving the music is selected to let the user's mind wander, and for the transitional driving state the music is selected to get the user in the mood for the next activity. A conversation agent may similarly be controlled/configured depending on the driving state, such as inactive during an observant driving state, in a “daily stresses” mode during routine driving, a brain reboot or mental reset mode during effortless driving, and a role transition mode during transitional driving. The desired effect, in terms of state of mind, for each driving state may include or may be: cautious for observant driving, at ease for routine driving, serene for effortless driving, and forward looking for transitional driving.

The systems and methods disclosed herein help travelers feel better when they step out of a vehicle than when they got in by providing the right intervention (or an appropriate intervention) at the right time, in the right circumstance, for the right person, without command-making the systems and methods a responsive digital health experience. This improves wellbeing of the travelers and makes driving safer, easier, more fun, and more productive. Such systems and methods my utilize embedded sensor technology and location application programming interfaces (APIs), and other APIs, to deliver the physical and infotainment interventions. The systems and methods use empathetic AI, as discussed, by sensing, understanding, and effectively supporting a traveler during any state of driving. The systems and methods determine emotional dynamics in a vehicle and select appropriate interventions to modify or support certain emotional dynamics. This reduces traveler distress and increases traveler wellbeing, which may improve driving performance, creative thinking, safety, mood regulation, and environmental mastery.

Modifications to levels of energy (which in some cases may be simply tempo), approachability, engagement, and sentiment may in some cases rely on predefined definitions. For example some predetermined tempo or energy may be predefined as zero energy, another predetermined tempo or energy may be predefined as 100% energy, and all tempos in between may then be categorized as some percentage of 100% (while tempos below the 0% threshold may still be considered 0% and tempos above the 100% tempo may still be considered 100%). Similar predeterminations may be made with respect to lowest and highest levels for energy (if it is defined as something other than tempo), approachability, engagement, and sentiment (or valence), with all levels in between then characterizable as some fraction of 100% of that characteristic. Thus, if the system is currently playing a song that is considered to have 50% energy level and the user is speeding, a 20% decrease in energy level may mean the system reduces the energy level to 30% (or alternatively a 20% decrease could mean a decrease by 20% of the 50%, which would mean a decrease down to a 40% energy level).

Location and other application programming interface (API) information that may be gathered by the system and/or used by the system for determining trip progression may include: the evolution of a trip including duration (or expected duration) of a trip vs. typical or average duration of prior trips on the same route, type(s) of roads, structural interruptions/notable markers (such as toll markers); traffic info (green, yellow, red, or for example traffic traveling at least the speed limit, traffic traveling 10+ miles per hour below the speed limit, and traffic traveling 20+ miles per hour below the speed limit); incidents and other criticalities along the trip route; a predefined jam factor (for traffic jams); and lane level traffic information. Other elements may be used to determine trip progression, and some of these may be excluded, as this is simply one example.

Location and other application programming interface (API) information that may be gathered by the system and/or used by the system for determining trip conditions may include: weather; time of day; and actual speed vs. speed limit. Other elements may be used to determine trip conditions, and some of these may be excluded, as this is simply one example.

Location and other application programming interface (API) information that may be gathered by the system and/or used by the system for determining trip intent may include a starting point and a destination. Other elements may be used to determine trip intent, and some of these may be excluded, as this is simply one example.

Referring to FIG. 17A, it is pointed out that in implementations the communication chip can be used to receive weather data, traffic data, toll data, speed limit data, data regarding crashes, and so forth. Some data may be stored in memory as well, for later use, such as toll data, speed limit data, driving pattern data (regarding the driver currently driving, or vehicles in general, or any other driving pattern data), and so forth. It is further pointed out that the communication chip can include more than one chip. The communication chip and/or the vehicle sensors can include one or more NFC communication chips or devices to allow near-field communication(s) with nearby devices, such as smart phones, tablets, smart watches, and any other NFC-capable devices. The CPU and/or memory of FIG. 17A, and/or the communication chip, may be used to provide data and instructions/control commands for drive assist features. These may be updated and/or adjusted over time, such as using machine learning which is trained over time using the patterns of a specific driver and vehicle and/or of a plurality of drivers and/or vehicles. The CPU and/or memory of FIG. 17A may also include code and/or instructions which, when executed by the CPU, control vehicle lighting, audio, temperature, humidity, air quality, in-vehicle fragrance release, and any other details or controls of an in-vehicle environment. Although not shown in FIG. 1 or 17A, the system 100 may include, within or coupled to the vehicle, acoustic filters or other noise-reducing or noise-canceling elements, such as to reduce or cancel noise within (or entering) the cabin of a vehicle.

### Music Analysis and Indexing

With respect to the music analysis and indexing, the music industry analyzes songs either artistically by academic musicologists or for advertising-related purposes, by genre or mood. Neither method prioritizes the listener, who approaches music very differently. In his seminal white paper “Perceived emotion and felt emotion: same or different,” Professor Alf Gabrielsson distinguishes between emotion felt by the listener (the “internal locus of emotion”) and the emotion music is expressing (the “external locus of emotion”). The system 100 approaches song analysis from a listener's perspective, understanding songs the way the music is experienced internally.

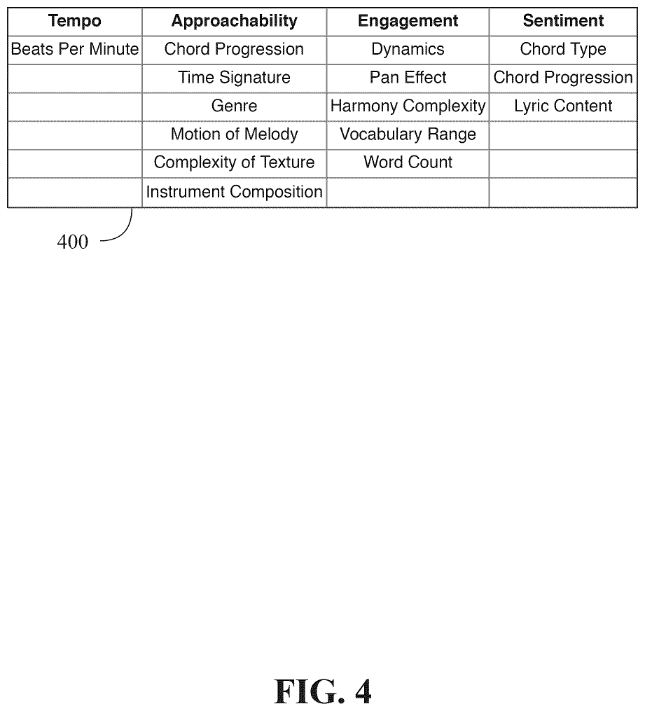

Referring to FIG. 4, table 400 representatively illustrates that the system classifies each song according to four criteria: its tempo (defined by its beats per minute), its approachability (defined by how accessible vs. challenging the song is to the listener), its engagement (meaning whether it is a lean forward song, e.g. requiring attention, or a lean backward song, e.g., being in the background) and its sentiment (defined by the mood a song intends to create within the listener). A description of each of these analysis criteria is provided below.

### Tempo

Beats per minute is the metric used to define the speed at which the music should be played (the tempo).

### Approachability

Chord Progression—Common chord progressions are more familiar to the ear, and therefore more accessible to a wider audience—popular in genres like Rock and Pop. Genres such as Classical or Jazz tend to have more complex, atypical chord progressions and are more challenging. Tables 500 of FIG. 5 show a number of common chord progressions. The system and method could use any of these chord progressions, or other chord progressions, to categorize any given track along a spectrum of typical to atypical chord progression.

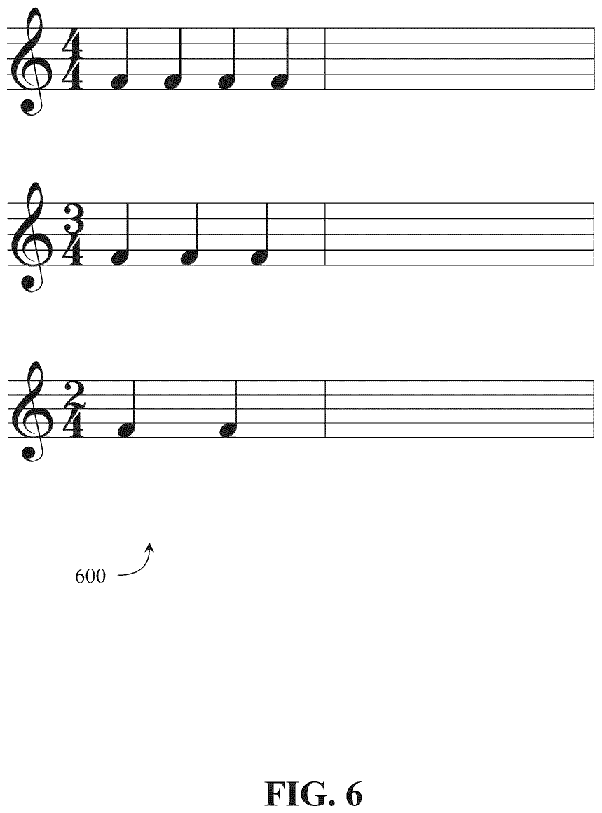

Time Signature—Time signature defines the beats per measure, as representatively illustrated in diagram 600 of FIG. 6. The most common and familiar time signature is 4/4, which makes it the most accessible. 3/4 is significantly less common (and therefore marginally more challenging), but still relatively familiar, as heard in songs such as Bob Dylan's “The Times They Are A-Changin'.” Uncommon time signatures such as 5/4 (e.g., Dave Brubeck's “Take Five”) are more challenging as they are more complex and engaging than traditional time signatures. Also worth nothing is that songs can have varying time signatures. As a non-limiting example, THE BEATLES' “Heavy” is 4/4 in the verses and 3/4 in the chorus. FIG. 6 only representatively illustrates the 4/4, 3/4, and 2/4 time signatures, but the system and method may determine and assess approachability according to any time signature, including by non-limiting examples: simple (e.g., 3/4 and 4/4); compound (e.g., 9/8 and 12/8); complex (e.g., 8/4 or 7/8), mixed (e.g., 5/8 & 3/8 or 6/8 & 3/4), additive (e.g., 3+2/8+3), fractional (e.g., 2½/4), irrational (e.g., 3/10 or 5/24), and so forth.

Genre—More popular and common genres of music such as Rock, R&B/Hip-Hop, Pop, and Country are more accessible. Less popular genres like Electronic Dance Music, Jazz, and Classical can be less familiar, and more challenging. The systems and methods may accordingly use the genre to categorize a track as more or less approachable, accordingly.

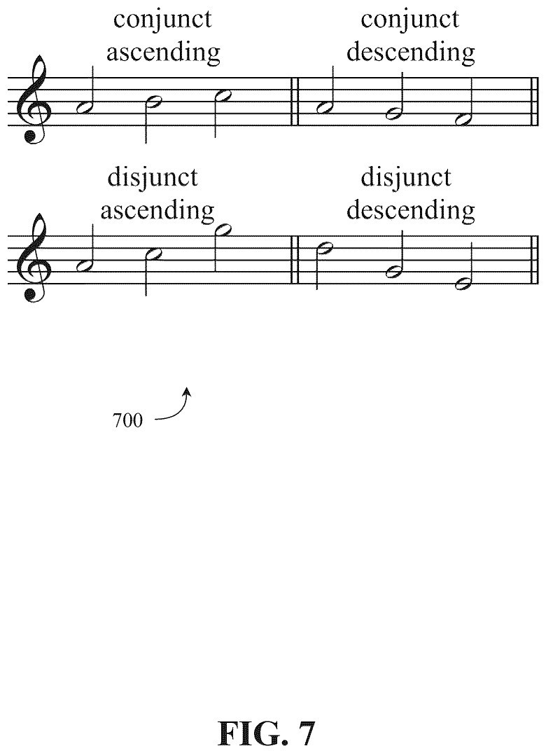

Motion of Melody—Motion of Melody is a metric that defines the variances in a melody's pitch over multiple notes. This is representatively illustrated by diagram 700 of FIG. 7. Conjunct melody motions have less variance, are more predictable, and are therefore more accessible (i.e., more approachable), while disjunct melody motions have a higher variance, are less predictable, and more challenging (and so less approachable).

Complexity of Texture—In music, texture is used to describe the range of which the tempo, melodies, and harmonics combine into a composition. For example, a composition with many different instruments playing different melodies—from the high-pitched flute to the low-pitched bass—will have a more complex texture. Generally, a higher texture complexity is more challenging (i.e., less approachable), while a lower texture complexity is more accessible—easier to digest for the listener (i.e., more approachable).

Instrument Composition—Songs that have unusual instrument compositions may be categorized as more challenging and less approachable. Songs that have less complex, more familiar instruments compositions may be categorized as less challenging and more approachable. An example of an accessible instrument composition would be the standard vocal, guitar, drums, and bass seen in many genres of popular music.

### Engagement

Dynamics—Songs with varying volume and intensity throughout may be categorized as more lean-forward, while songs without much variance in their volume and intensity may be categorized as more lean-backwards.

Pan Effect—An example of a pan effect is when the vocals of a track are played in the left speaker, while the instruments are played in the right speaker. Pan effects can give music a uniquely complex and engaging feel, such as THE BEATLES' “Because” (lean-forward). Songs with more or unique pan effects may be categorized as more lean-forward, while songs with standard or minimal pan effects are more familiar and may be categorized as more lean-backwards.

Harmony Complexity—Common vocal or instrumental harmonic intervals heard in popular music—such as the root, third, and fifth that make up a major chord—are more familiar and may be categorized as more lean-backwards. Uncommon harmonic intervals—such root, third, fifth and seventh that make up a dominant 7 chord—are more complex, uncommon, and engaging and may be categorized as more lean-forward. THE BEATLES' “Because” is an example of a song that achieves high engagement with complex, uncommon harmonies.

Vocabulary Range—Vocabulary range is generally a decent metric for the intellectual complexity of a song. A song that includes atypical, “difficult” words in its lyrics is more likely to be described as lean-forward—more intellectually engaging. A song with common words is more likely to be described as lean-backwards—less intellectually engaging.

Word Count—Word count is another signal for the complexity of the song. A higher word count can be more engaging (lean-forward), while a lower word count can be less engaging (lean-backwards).

### Sentiment

Chord Type—Generally, minor chords are melancholy or associated with negative feelings (low sentiment) while major chords are more optimistic or associated with positive feelings (high sentiment).

Chord Progression—If a song goes from a major chord to a minor chord, it may be an indication that the sentiment is switching from high to low. If the chord progression goes from major to minor and back to major it may be an indication that the song is uplifting and of higher sentiment. Other chord progressions may be used by the system/method to help classify the sentiment of a song.

Lyric Content—A song that has many words associated with negativity (such as “sad,” “tear(s),” “broken,” etc.), may likely be of low sentiment. If a song has words associative with positivity (such as “love,” “happy,” etc.) it will more likely be of high sentiment.

### Context Determination

Referring back to FIG. 2, The determine context step may be accomplished using a unique data collection, analysis, and management system. The innovative underlying belief related to system 100 is that every kind of listening occasion deserves its own experience. Therefore, the listening experience in implementations includes a design constraint: the experience is determined by the occasion and its specific qualities. Based on this philosophy, there are seven major context attributes that, in implementations, define a listening occasion, and are the categories that are used to determine set criteria based on predetermined conditions that are stored in the one or more databases.

Type of Space—Where is the user listening? In a car, in a public space like an art studio or at work? At home?

Space Conditions—How loud is the space? How many different people are talking? At what decibel level? What is the weather like? If the user is in a car, the attributes will be navigational in nature (e.g., How will the drive evolve? Will the type of road change, for instance from city to highway? Will there be traffic jams? Will there be toll roads? Etc.).

For other spaces, like an art studio, the attributes will be situational in nature (e.g., How loud is the space? How many different people are talking? At what decibel level?).

Intent—What is the purpose of the occasion? For instance, in the car: Is it a commute, an errand, a trip to a meeting, a road trip? Or in an art studio: Is it a creative activity occasion, or a social event?

Social Dynamic—Is the listener alone, with friends, or with weak social connections? How many? The listening experience will in implementations be dramatically different depending on the social context.

State of Mind—Is the listener reflective? Frustrated? Does s/he need to reboot their brain?

Regularity of the occasion—Is the occasion part of a larger pattern? Is it a recurring, even regular event? Is there a time pattern to it? Are there certain behaviors associated with this particular occasion? Are routine choices being made?

Time Frame—Is there a length of time associated with the occasion or is it open-ended? If in the car, what is the trip duration? If an event, is at regularly recurring with clear beginning and end?

These unique context attributes have been selected based on years of structured studies of human behavior as it relates to music listening and similar activities. A database of possible scenarios, based on differences in these seven attributes, has been tested on hundreds of unique occasions and has proven to capture every possible scenario as long as these seven qualities are properly understood. Accordingly, the system 100 may, using stored scenarios (stored in the database) associated with various combinations of the seven attributes through the database, determine based on gathered information related to the seven attributes which scenario(s) apply.

Information provided by a phone, smart speaker (e.g., GALAXY HOME), connected home devices, application information (like geo-location), sensors and other information may be accumulated over time in order to assess the aforementioned qualities of context. This data input in implementations may be precise and manageable as it is derived only from concrete sources available at the location. For example, a car navigation app is already able to present the last destination entered, store destinations, and so on. The system in implementations determines the context by combining, tracking and analyzing the information gathered so that it can learn and adjust based on previous behavior and so that the same information can be used in other services, not only in the application from which it was sourced. In other words, the accumulated data collected may be shared among various applications and services instead of being isolated.

Each listening occasion may contain data from various sources including a phone, vehicle sensors, a navigation application, a vehicle infotainment system (including the speaker system), connected external devices (e.g., a laptop), and so on. The system in implementations synthesizes the information in order to make inferences about the qualities of context that define each occasion. Examples of how data can be derived for each of the seven attributes is given below.

Type of space can be determined via geolocation apps and/or by identifying the location of the speaker system (if apart from a mobile device) used to stream the music set.

Space attributes may be navigational (if in a vehicle) or situational. Navigational attributes may be derived from a vehicle's GPS system or from a mobile device's GPS system. Situational attributes can be derived via sensors and apps of a mobile device or vehicle. For instance, a decibel level of the space, and whether (singular or dialog) speech is present, and at what level, may be determined by microphones of a mobile device or vehicle.

Intent can be derived by analyzing the cumulative historical information collected by calendar entries and/or a navigation system (e.g., the number of times a particular location or destination was used, the times of day, as well as other accessible information). The navigation system could be a third-party app on a mobile device and/or a navigation system of a vehicle.

The social dynamic can be deduced by the type of space, voice and face recognition sensors of a mobile device and/or vehicle, biometric sensors of a mobile device and/or vehicle, the infotainment selection or lack thereof, the types and quantity of Near Field Communication (NFC) objects recognized (e.g., office keycards) by a mobile device and/or vehicle system, and so on. For instance, if the listener uses the headphone jack of a mobile device (device 118), it may be determined to be a private listening situation. If the speaker system in a public venue is accessed, it may be determined to be social listening.

The space occupants' state of mind can be determined via biometric, voice, face and eye movement recognition sensors of a mobile device and/or vehicle system, the usage of a climate control system (e.g., heat) of a vehicle or building, and so on. For example, a driver of a vehicle may be in a bad mood (as determined by gripping the steering wheel harder than usual and their tone of voice, use of language, or use of climate control system) and may be accelerating too quickly or driving at a high speed.

The conditions can be sourced through apps (e.g., weather app) of a mobile device, temperature sensors of a mobile device or vehicle system, and/or other external sensors.

Regularity of the occasion can be determined through cumulative historical geo-positional data from a map application of a mobile device or vehicle system, calendar patterns of a calendar app of a mobile device or vehicle system, and which devices are communicatively coupled with the system near to a user's device 118 (for example this may be a regular outing with friends that repeats each week so that the friends' phones are in close proximity with the user's phone as determined by NFC information).

If there is a time frame, it may be determined through calendar entries of a calendar app of a mobile device or vehicle system, a navigational application of a mobile device or vehicle system, or regular patterns.

The system 100 performs the context determination by analyzing each data point relating to a particular occasion and providing direction for every music set. It remains flexible, so that it can adjust to changing conditions (e.g., during a drive, if the road changes from street driving to highway driving, there may be different requirements for the music attributes).

The system outputs a precise description of the situation to define the set criteria. This output in implementations has a brief handle, in implementations linked to the intent of the occasion to summarize it. For instance: commute to work; create at art studio; happy hour at work; relax at home

With the concise handle comes additional information which informs whether it is private or social listening, whether the set will be open-ended or have a specific duration, whether it needs to be prepared to adapt to changing conditions, etc.

In implementations the context determination may be done by one or more software applications or executables of the system 100 which may be termed the Context Determiner.

### Set Requirements

Once the context is identified, the corresponding music requirements can be determined. Only music that fits the criteria of the determined context (based on tempo, approachability, engagement, and sentiment) will be funneled into a narrow subset to be available to be mixed and played after the user preferences are applied.

It is pointed out again here that the music compilation of system 100 is internally listener-centric, rather than externally music industry-centric. That means that it is the context, rather than the general taste, popularity, or musicology attributes, that determines the type of music that qualifies for a particular set. For example, referring to FIG. 8, table 800 representatively illustrates that while traditional music genres might include categories like Rock, Hip-Hop, Classical and Reggae, and while streaming services might include categories like Chill, Finger Style, Nerdcore and Spytrack, the system 100 allows for unique context-specific genres such as Commute to Work, Exercising at Gym, Cleaning the House, Creating at Art Studio, and so forth.

Users tend to listen to different types of music depending on the context. For instance, a user will listen to different music when alone in the car on the way to work than when driving his/her 9-year old daughter to school. Private listening allows for more challenging music. When a user is in a social setting, especially with weak social connections, the music may need to be more approachable to satisfy a wider range of acceptability. A favorite song of a particular user may be inappropriate for certain occasions, or during certain mind-sets that the user experiences.

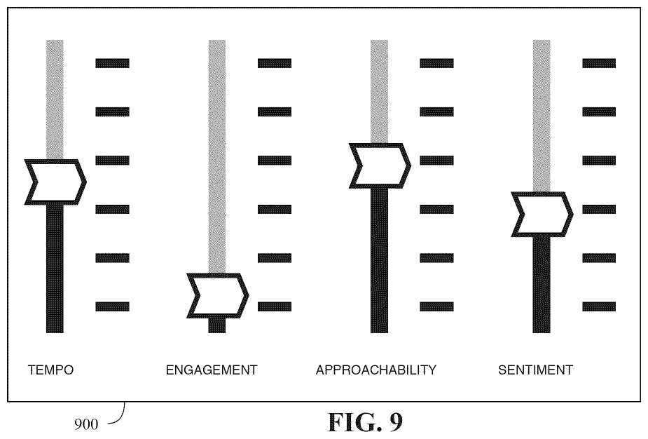

An example will now be given of how the music analysis based on tempo, engagement, approachability, and sentiment works based upon different context. A music set for a long commute to work may, using the system 100, change going from normal highway travel to a traffic jam. On the highway during normal-speed driving, mid-tempo songs are useful to discourage speeding while keeping engagement low so that the traveler's mind can wander in a healthy way. Approachability can be varied based on the composition of passengers in the cabin and the sentiment may be low-key or neutral. These settings are represented by diagram 900 of FIG. 9.

FIG. 10, on the other hand, representatively illustrates how the system may respond to a sensed traffic jam (sensed for instance through mobile device or vehicle system GPS data). During the traffic jam the tempo goes up, the engagement switches from low to high, going from background music to lean forward music to distract the traveler from the frustrating road conditions, and the sentiment switches to positive and optimistic.

In essence, the set requirement stage defines the levels each of the four key song qualities (type of tempo, type of engagement, type of approachability, and type of sentiment) need to contain to qualify for any particular situation. For example, for a “Commute to work on highway” context, in implementations only those songs that are mid-tempo, low engagement, mid to low approachability (for a singular passenger) and mid sentiment will be considered, regardless of other criteria (like genre, era, etc.).

### Music and Context Matching

Referring back to FIG. 2, the music and context matching step represents the system collecting songs that are deemed appropriate for the determined context, based on the prior song analysis. This step may be performed by one or more software applications or executables or by a software engine which may be termed the “Music and Context Matcher.” The music and context matching step is akin to a DJ preparing for an event. Depending on the type of event and the anticipated audience, s/he picks different music, from his/her entire collection. The DJ may not know what to play until s/he gets to the event and gets a sense of the actual audience, so s/he will have more than what will actually be played in the handpicked subset that has been brought. Similarly, the system may select more songs than can actually be played in the allotted time, and mix them according to how the context changes or remains the same. Nevertheless, if the context changes, the system may dynamically do one or more additional context determination steps and redefine the set criteria while a set is already being played.

### Set Catalog

The result of the music and context matching is the subset of the meta music catalog that includes only songs made available for mixing. In the case of a major streaming music catalog, the resulting subset of songs would still reach several thousand, if not even hundreds of thousands, titles for any scenario. This step may be thought of as an alternative genre classification. As indicated earlier, the music industry defines songs either according to genre (e.g., rock, jazz, country) or mood (such as “chill”). Instead, system 100 categorizes the music catalog according to the music listening occasion, like “Commute in car to work” or “Artistic Work at Ceramic Studio with multiple listeners.” If the listener so chooses, s/he can then narrow the set catalog even further by specifying a specific genre, artists, or playlist, and conversely by excluding the same (this is the “Apply User Preferences” step).

### Mixing the Set

The system 100 mixes the music set. This mixing may be done by a software engine implemented on one or more servers of the system and/or locally on device 118, and the software engine may be termed a “Turntabler.” The system applies DJ-style tools and rules to the subset of appropriate songs identified for a set and then outputs a modified version of the songs. The Turntabler brings the artistry of a DJ to music streaming. It ensures that structure is added to the playlist, it progresses each set based on tempo and harmonic compatibility, and it determines where to mix the tracks, identifying the natural breaks in each song to smoothly transition.

The Turntabler's algorithm curates the right song order for each set. It determines when to bring the vibe up, when to subtly let the mood drop, when to bring the music to the forefront, when to switch the music to the background, when to calm and when to energize. It works seamlessly with all sensors and relevant data inputs of devices 118 and/or vehicles 122/124 or buildings 128/130 to know whether the set has a particular duration (e.g., on a drive as determined via the GPS of device 118, at the gym as determined via the GPS of device 118, at home doing chores as determined via the GPS of device 118 and smart appliance input to the system through the telecommunications network) and when to switch the style. In implementations the Turntabler has the following functionalities.

Harmonizer—The Harmonizer identifies the key of each song to understand other harmonically compatible tracks. Like a professional DJ, the software will move around the key of the Wheel of Harmony (i.e., the circle of fifths 1100 represented in FIG. 11) and within the inner and outer wheels with every mix, progressing the soundtrack.

Cross Fader—The Cross Fader determines the transition from one song to another during a set and is used together with the Beat Matcher (see below). One way that songs are mixed is to have a single song playing, bring a second song in so that both songs are playing simultaneously, and then fade out the first song so that only the second song continues. More songs may be added in as well (as opposed to layering only two songs).

The Cross Fader utilizes a Cue Point feature to mark where to mix, identifying the natural breaks in each song to smoothly overlay them. It identifies particular times during a song that are best suited to transition (e.g., Where is the first beat? Where is the breakdown? Where do the vocals come in? In implementations Intros, Choruses, Breaks, Instrumentals, and Outros are the best sections to do a fade). Diagram 1200 of FIG. 12 representatively illustrates this, where sound profiles of a first track (top) and second track (bottom) are analyzed to determine the most likely places of each track (shown in gray) to implement a switch/fade from one track to the other.

Beat Matcher—The Beat Matcher aligns the beats of two or more songs, so that they are in sync. In order for the beats to be in sync, the songs must be playing at the same or at a compatible tempo (as determined by the songs' BPMs or Beats Per Minute) and the beats must be in phase—i.e., the rhythmic notes (bass drum, snare drum, etc.) occur at the same times.

Equalizer Mixing—This feature is especially useful when mixing different genres and eras. It utilizes Volume Fading and Vocal Blending by adjusting the frequency to create smoother transitions.

Looper—This feature creates its own break when a song does not have a long enough section to facilitate a smooth transition, or when you are running out of time at the end of a set (e.g., when the GPS suddenly shortens the ride time during a drive). The Looper will identify a 2 bars/8 beats section of audio as transition.

Pace Setter—This feature adds the nuanced “soft skills” of expert DJs to ensure that the set has deliberate momentum, pace and structure. Rules like “no three hits in a row,” fluctuating energy (“warm up/main set/cool down”), add variety in genres and eras, the “push and pull” technique, “no repeating 8 (or 16) bars,” “don't overdo the effects,” etc., all add soul and gravitas to each set.

The Turntabler is a fully automated engine for mixing sets. While software exists to support musicians and DJs in mixing their own sets, these existing programs are disjointed and require manual supervision. The user has the option to use the Turntabler function context-free as well. If a user simply wants to mix a certain playlist (e.g., a personally compiled “Sunday morning” playlist), or the first four albums of R.E.M., the user can define a time frame (e.g., 30 minute set), Subset Library (e.g., includes all R.E.M. tracks and the “Nevermind” album from NIRVANA), and have the system 100 create a mixed set without considering contextual set requirements. This is especially useful for users who want to share their personal set lists, or for users at certain occasions (for instance, if a user simply wants to relax on the sofa and listen to 20 minutes of RADIOHEAD, sampled and mixed in tempo and harmony).

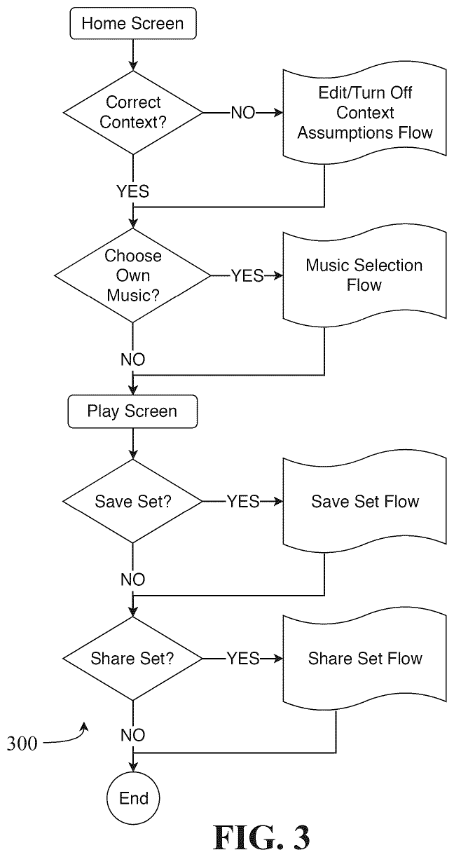

Referring now to FIG. 3, a flow diagram 300 is shown which representatively illustrates various options for a user to implement using system 100 to affect the music compilation. These may be implemented, for example, using user interfaces 1300, 1400, 1500, and 1600 of FIGS. 13-16, which are displayed on display 120 of device 118. In implementation the music compilation is configured to occur automatically when a user presses a Play button (for example the Play button of interface 1300), so that when the user selects Play the appropriate mix for the occasion automatically starts.

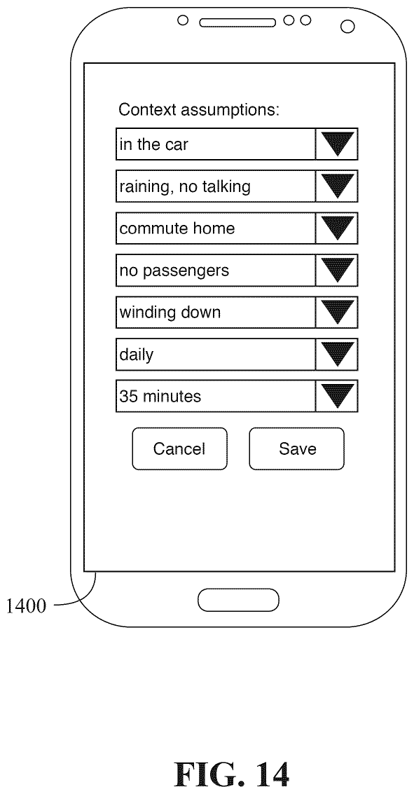

However, the user has several options for modifying the music set. FIG. 3 shows that the first decision is whether the context is correct. FIG. 13 shows that the context selected for the user is “Commute Home.” If this context is correct, the user can simply leave the music playing (or press Play to start the music, if Play has not already been selected). The user can at any time, however, select the Change selector to change the context manually. Alternatively, the user may select the Turn Off selector to turn off the context engine altogether (such as to have the system/app mix a specific mix-set, like one based on genre, a playlist, an artist, or an album, that is not determined by context) (in implementations the user may also specify music with the context engine on). The selectors described herein could have different names, for example the Turn Off selector could in other implementations be named the Ignore selector but accomplish the same function. In implementations when the user selects the Change selector a user interface such as interface 1400 of FIG. 14 is shown, which shows various algorithmic-selected context assumptions and allows the user to modify them. The topmost attribute is “type of space,” which in the implementation shown is “In the car,” the next attribute is “space conditions” which in the implementation shown is “raining, no talking,” the next attribute is “intent” which in the implementation shown is “commute home,” the next attribute is “social dynamic” which in the implementation shown is “no passengers,” the next attribute is “state of mind” which in the implementation shown is “winding down,” the next attribute is “regularity of the occasion” which in the implementation shown is “daily,” and the last attribute is “time frame” which in the implementation shown is “35 minutes.” The user may select any of these dropdown menus to change the algorithmically-selected defaults and then select the Save or Cancel selectors. In implementations the user interface may use selectors other than dropdown menus but with a similar selection function (the same goes for all other selectors described herein for the user interfaces, any type of selector now known or hereafter discovered may be used, and those shown in the drawings and described herein are only representative examples). The Cancel selector returns the user to the home screen (interface 1300) without making any changes, while the Save selector enacts the changes reflected on interface 1400 to adjust music play and returns the user to the home screen. In FIG. 3 the step of selecting either the Change or Turn Off selector (and, if the Change selector is selected, modifying the selections) is shown by the “Edit/Turn Off Context Assumptions Flow” step.

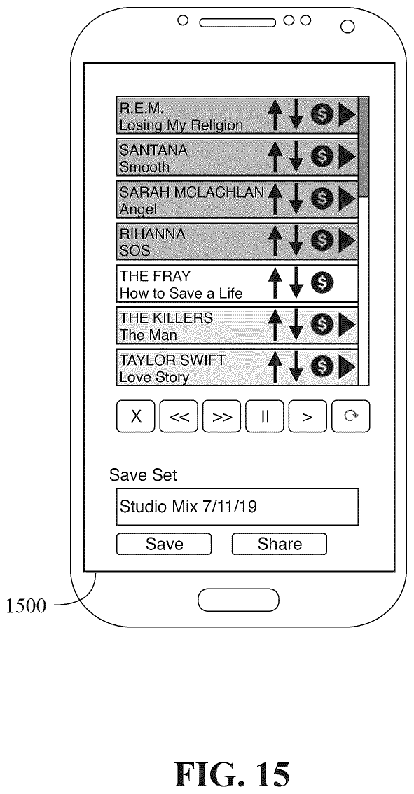

Referring again to FIG. 3, if the user elects to choose his/her own music then the music begins once the user selects Play (and the music is either selected based on context, if the context engine is on, or not based on context if the context engine is off). If the user selects not to choose his/her own music, then the music begins when the user selects Play (and again the music is either selected based on context, if the context engine is on, or not based on context if the context engine is off). Once Play is selected, the Play Screen is shown, which is representatively illustrated by interface 1500 of FIG. 15. This interface shows a set list. In the set list, artist and title information is displayed along with functions such as “Like” (up arrow), “Dislike” (down arrow), “Buy” which allows the user to purchase the track, and “Play” which allows the user to play any of the listed tracks immediately. The currently playing item in the list is visually distinct (in this case white background) from music previously played (dark grey background) and music that has yet to be played (light grey background). Audio controls are presented (in this case they are represented below the set list) and may include any number and variety of controls, in this implementation the example controls from left to right are Stop (represented by an X) to stop play and return the user to the home screen, Skip Back to play the previous track (represented by <<), Skip Forward to skip the currently playing track (represented by >>), Pause to stop play but stay on interface 1500 (represented by | |), Play to un-pause and start play again (represented by >), and repeat to play the current track one more time after it finishes (represented by a curved arrow symbol). Other audio controls could be included on interface 1500.

Interface 1500 also shows a selector to save the set and a selector to share the set. In the flow diagram of FIG. 3 these are in the order of Save first and Share second, but this is only one example. In implementations the user could save a set and then share it, or share the set first and then save it, or the user could save the set and not share it, or share the set and not save it. In FIG. 15 a default name and date (defaulted to today's date) is provided by the system, but the user can select inside the name field to edit the name, such as with the device's built-in typewriter function. Selecting the Save selector will save this mix so that the user can play it at any later date. For example it may be one of the options available through the dropdown “Choose my own music” selector of interface 1300—which if played could default to play the set with the context engine off in the same order it was previously played or could be played with the context engine on to play the same songs but possibly mixed in different orders and ways based on context. Selecting the Share selector will bring up options to allow the user to share the set details with others through email, social media, text, and so forth. In implementations what is shared may be a link which invites the person to install the app to listen to the set or, if they have already installed the app, a link to begin playing the set. In other implementations what is shared may simply be a list of the artists and songs.

Finally, FIG. 3 shows an End after the user has saved and/or shared the set. In implementations, however, the user may save and/or share a set while the set is still playing, and the set may be dynamically added to if the context engine determines that the set should be added to (such as a commute or activity taking longer than originally expected). Additionally, in implementations if the user never selects Stop or Pause, the system 100 may simply keep the set going and dynamically alter the set as the context changes throughout a user's day.

Referring back to FIG. 13, it is also pointed out that the topmost user-selected name (User538) indicates a logged-in state. If the user selects the username by tapping it the user may be taken to an account screen (not shown) to modify user details, such as username, contact information, and other details. The “Choose my own music” selector may allow the user to choose based on genre, available music catalogs associated with the user (e.g., SPOTIFY, PANDORA, locally stored music, etc.). In the drop down menu/text field for choosing specific music the user could also enter a specific playlist, artist, album, or other input. The text field if typed in provides autocomplete options based on available music catalogs associated with the user.

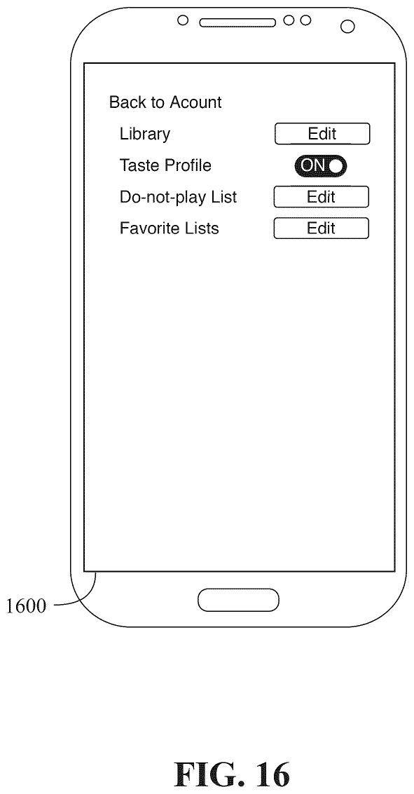

FIG. 16 shows interface 1600 which may be accessed from an Account interface (not shown). Account set up may be fairly standard. The user creates an account and may add other subscription libraries (e.g., SPOTIFY, PANDORA) through credential verification and can add their personal library, this may be initiated for instance by selecting the Edit selector next to “Library” on interface 1600. Music libraries can also be added later, at any time after account setup. The Library “Edit” button brings up a screen that is not shown in the drawings but which allows the user to see the libraries/catalogs already associated with the account (e.g., SPOTIFY), add new libraries/catalogs to be aggregated into the Meta Music Catalog (e.g., PANDORA), and delete or disassociate (e.g., remove credentials for) libraries/catalogs that are currently included in the Meta Music Catalog.

In implementations Favorite lists (from which to mix) can be added as well. For instance, if a user has favorite genres, artists, albums or subscription playlists from which to mix, then they may be listed and/or edited using the Edit selector next to the Favorite Lists wording. Another feature is the “DO NOT PLAY” option. The user can choose to avoid specific genres, artists, songs, albums, eras, popularity levels, and so forth to not play. The user can furthermore choose to do so “always” or just “sometimes,” and then specify further on which occasions to not play the specified choice. Popularity levels may be listed as “all,” “top 80%,” “top 50%,” and “top 20%,” with “top 80%” as the default option for this app. Popularity may be measured by numbers-of-play within the Meta Music Catalog. Cutting off the bottom 20% may help ensure that only professionally recorded songs will be available, yet ensure variety. An advanced setting allows the user to set conditions for the Do-not-play list (e.g., only during specific contexts).

While certain types of selectors have been described above, any type of selectors and fields common in mobile device apps may be utilized to implement the user interfaces while still maintaining the functionalities generally described herein. Taste profile is “On” by default, which means that the user agrees to let the system 100 analyze his/her Meta Music Catalog to identify preferences (e.g., preponderance of a particular genre or artist) and patterns (e.g., most played songs). The user may turn this off as desired. The user may view and edit his/her favorite sub-catalogs, similar to the functionality provided in the SONOS software application.

As has been pointed out to some extent above, the system and methods may be used to provide a listening experience that includes partial tracks. In some implementations the system may provide a compiled music set that includes only partial tracks, all mixed together so that transitions happen at appropriate times. In other implementations a compiled set may include only full tracks, or some full and some partial tracks. Music listening using the systems and methods described herein is, in implementations, more artistic, deep, meaningful, personalized, and intimate than the common linear streaming experiences of similar-sounding songs. In implementations in which the system creates a music set that is only partial tracks, it may be more accurate to call the set a “sample set” as opposed to a playlist—the system in such implementations is allowing the user to sample various tracks without listening to any track in its entirety, and in an intelligently mixed manner with useful transitions and transition points.

To recap some of the details of the systems and methods, the turntablism style results in the creative augmentation of any music catalog. It creates a new form of streaming music: a sequence of songs mixed together to appear as one continuous and seamless track. Not only is the outcome truly original, it is also true to the actual listening behavior of people since songs are often not listened to until completion. One SPOTIFY commissioned study found that the likelihood of a song being skipped in the first 5 seconds of play is 24.14%, and that the likelihood rises to 48.6%, before the song is finished (so that listeners skip, on average, every other song). The systems and methods disclosed herein (to make a compilation set of samples enhanced by DJ techniques and rules rather than a string of entire songs) will in implementations change the way people listen to music.

The contextual nature of the systems and methods, making the system aware of situations, social settings and surroundings, allows the system the ability to flexibly adjust in real time if contextual factors change. Comprehending the context for each listening occasion allows the app to develop an intimate relationship with the audience. Each set is achieved through a symbiotic relationship between the app, the audience, and the setting. Each set is shaped to match the particular occasion and curate the right song order and vibe progression. That makes the music play a contextualized experience. The system is like a virtual DJ who knows how to read a room and respond to its vibe.

The systems and methods are also dynamic. Some traditional streaming music services are linear and static, meaning the songs being played are all similar to each other, there being no structure to them other than generic theme. Songs in these traditional music services are randomly picked from a plurality of similar songs, making it unlikely that the music application always plays music suitable for the conditions of the listening occasion. In contrast, with the systems and methods disclosed herein the song progression is intentional and adaptive: songs are the building blocks of the sets and are chosen in relation to the relevant factors that define a particular situation.

Additionally, the systems and methods are largely automated so that music playback may occur with only the selection of the Play selector. This starts play of the set automatically once the situation is understood. No other prompts are needed (unless the listener wants to choose the option to specify certain artists, genres or playlists to mix).

The DJ-like elements of the system and methods disclosed herein bring artistry to music playback and add longitudinal structure to each set that does not exist in traditional music streaming services. The system and methods make the music listening more of an artform and a journey. They may allow for more diverse music sets, with more musical variety, while still seamlessly weaving the tracks together in a DJ-like style.

The interfaces of FIGS. 13-16, as described, may be implemented using a software app installed in a vehicle's infotainment system or on a mobile device such as a phone, tablet or the like. The system 100 may gather information in a variety of ways to know how to mix the set. For example, if the app is launched while computing device 118 is in an art studio the system may geo-detect that this is the location (using the mobile device's GPS capability). Attributes like length of play (of the entire set) would not apply in this scenario (unless there is a pattern to it, like a repeating hour-long class in the art studio every Thursday). Social dynamics can be detected by the amount of sound signals detected by the device's microphone. The more people are in the space, the more mainstream (approachable) the music may need to be. State of mind may also be gathered through sensors, for instance what tones are being used in conversation. Conditions may or may not apply. For example, heavy weather may cause the system to adjust sentiment. Pattern recognition, as described above, may adjust the set—for example of the visit to the art studio is for a class that is every Tuesday from 5 pm-7 pm then the set may be adjusted to last exactly two hours.

It is pointed out here that the systems and methods disclosed herein may in implementations include playing sample sets that include not only music that a user has previously listened to through the one or more third-party music streaming services (or personal music library), but also music from those subscribed third-party streaming services that the user has not previously listened to but which match with user preferences as determined by the system 100.

Music compilation systems and methods disclosed herein may include any details/aspects of music compilation/playback disclosed in the Parent applications.

In places where the phrase “one of A and B” is used herein, including in the claims, wherein A and B are elements, the phrase shall have the meaning “A or B.” This shall be extrapolated to as many elements as are recited in this manner, for example the phrase “one of A, B, and C” shall mean “A, B, or C,” and so forth.

In places where the description above refers to specific embodiments of music compilation systems and related methods, one or more or many modifications may be made without departing from the spirit and scope thereof. Details of any specific embodiment/implementation described herein may, wherever possible, be applied to any other specific implementation/embodiment described herein.

What is claimed is:

1. A music compilation system, comprising:
a computer processor; and
a media storing instructions executable by the computer processor, wherein the instructions, when executed, facilitate the music compilation system performing operations comprising:
storing data in one or more databases, the data associating a user with access credentials for one or more music libraries; and
in response to receiving a user selection, initiating play of a music set, wherein the music set comprises one or more portions of each of plural audio tracks;
wherein the system determines the portions of the plural audio tracks at least in part based on contextual information; and
wherein the contextual information comprises:
a listening history for the user;
and one or more of:
a time of day in which the music set is being played;
a day of week on which the music set is being played;
a regularity of an occasion in which the music set is being played;
a type of device on which the music set is being played; and
a location at which the music set is being played.

2. The system of claim 1, wherein the contextual information comprises both the time of day in which the music set is being played and the day of week on which the music set is being played.

3. The system of claim 1, wherein the contextual information further comprises a purpose of an occasion for which the music set is being played.

4. The system of claim 1, wherein the contextual information further comprises a type of the location in which the music set is being played, wherein the type of location includes one or more of: a road type; a location at, approaching, or leaving a home; a location at, approaching, or leaving work; a location at, approaching, or leaving a gym or exercise location; a location at, approaching, or leaving a restaurant; an in-vehicle location; a public location; and an art studio.

5. The system of claim 1, wherein the contextual information further comprises a condition of the location in which the music set is being played, wherein the condition includes one or more of: a temperature; an air pressure; a light condition external to a vehicle; a light condition internal to the vehicle; a weather condition; a road condition; a traffic condition; a position of one or more seats of the vehicle; a volume level; a window configuration of the vehicle; an air conditioning setting; and a heating setting.

6. The system of claim 1, wherein the contextual information does not comprise a user selection.

7. The system of claim 6, wherein the system compiles the music set by mixing portions of audio tracks by transitioning from a first portion of an audio track to a second portion of an audio track where the two portions of audio tracks are similar in one or more of harmony, tempo and beat.

8. The system of claim 7, wherein the transition from the first portion of an audio track to the second portion of an audio track is where the two portions of audio tracks are most similar in one or more of harmony, tempo, and beat.

9. The system of claim 8, wherein the system determines where the two portions of audio tracks are similar by analyzing sound profiles of the two portions of audio tracks.

10. The system of claim 9, wherein the system automatically modifies one or more of the two portions of audio tracks to increase its similarity to the other portion.

11. The system of claim 10, wherein the system adjusts one of a volume and a frequency of one or more of the two portions of audio tracks to increase its similarity to the other portion.

12. The system of claim 7, wherein transitioning from the first portion of an audio track to the second portion of an audio track comprises looping at least a part of one of the two portions.

13. The system of claim 7, wherein transitioning from the first portion of an audio track to the second portion of an audio track comprises aligning rhythmic notes of the two portions of audio tracks.

14. The system of claim 1, wherein the contextual information comprises one of: a state of mind of the user; and a social dynamic at the location.

15. The system of claim 1, wherein:
the audio tracks are categorized according to one or more of, a tempo, an approachability, an engagement, and a sentiment;
wherein: the tempo is defined as beats per minute; the approachability is defined by one or more of chord progression, time signature, genre, motion of melody, complexity of texture, and instrument composition; the engagement is defined by one or more of dynamics, pan effect, harmony complexity, vocabulary range, and word count; and the sentiment is defined by one or more of chord type, chord progression, and lyric content; and
wherein the system determines the portions of the plural audio tracks at least in part based on the categorization.

16. The system of claim 1, wherein the contextual information is updated and the music set is modified based on a change in the contextual information.

17. A music compilation system, comprising:
a computer processor; and
a media storing instructions executable by the computer processor, wherein the instructions, when executed, facilitate the music compilation system performing operations comprising:
storing data in one or more databases, the data associating a user with access credentials for one or more music libraries; and
in response to receiving a user selection, initiating play of a music set, wherein the music set comprises one or more portions of each of plural audio tracks;
wherein the system compiles the music set by mixing portions of audio tracks by transitioning from a first portion of an audio track to a second portion of an audio track where the two portions of audio tracks are similar in one or more of harmony, tempo and beat;
wherein the system determines where the two portions of audio tracks are similar by analyzing sound profiles of the two portions of audio tracks.

18. The system of claim 17, wherein the system automatically modifies one of the two portions of audio tracks to increase its similarity to the other portion, and wherein the modification includes one or more of: adjusting a volume of one of the two portions; and adjusting a frequency of one of the two portions.

19. The system of claim 17, wherein transitioning from the first portion of an audio track to the second portion of an audio track comprises looping at least a part of one of the two portions.

20. The system of claim 17, wherein transitioning from the first portion of an audio track to the second portion of an audio track comprises aligning rhythmic notes of the two portions of audio tracks.
